(19) United States
(12) Patent Application Publication
(10) Pub. No.: US 2026/0202861 A1
(43) Pub. Date: Jul. 16, 2026

(54) Agentic Framework for Long Horizon Task Planning and Execution Across Multiple Robots

(71) Applicant: Botco, Inc., San Francisco, CA (US)

(72) Inventors: Kyle Vogt, San Francisco, CA (US); Paril Jain, San Francisco, CA (US); Lukas Holoubek, San Francisco, CA (US)

(21) Appl. No.: 19/451,141

(22) Filed: Jan. 16, 2026

Related U.S. Application Data
(60) Provisional application No. 63/745,887, filed on Jan. 16, 2025.

(51) Int. Cl. G05D 1/69; B25J 9/16; G05D 1/225; G05D 1/689; G05D 101/15

(52) U.S. Cl. CPC G05D 1/69; B25J 9/163; B25J 9/1682; G05D 1/225; G05D 1/6895; G05B 2219/32335; G05B 2219/39001; G05D 2101/15

(57) ABSTRACT

A system and method for orchestrating multiple robots to accomplish objectives in dynamic environments. A network system receives an objective and determines actions required by accessing sensor information describing a current state of the working environment and accessing environment memory comprising a preferred state. The system applies a model to determine differences between the current state and preferred state, then determines actions to achieve the preferred state based on the differences. An orchestration engine orchestrates the actions among robots by determining skills of each robot based on skill libraries, assigning actions based on those skills, and generating an action plan that sequences the assigned actions. The network system transmits assigned actions to each robot for execution in the working environment.

### CROSS-REFERENCE TO RELATED APPLICATIONS

This application claims priority to U.S. Provisional Application Ser. No. 63/745,887 filed Jan. 16, 2025, which is incorporated by reference in its entirety

### FIELD OF DISCLOSURE

The present disclosure relates generally to robotic systems, and more particularly to systems and methods for coordinating multiple autonomous robots to accomplish complex objectives in dynamic environments through learned representations and adaptive training.

### BACKGROUND

Coordinating multiple robots to accomplish complex objectives in dynamic environments presents significant technical challenges. Traditional robotic systems rely on symbolic planning that requires manual specification of task decomposition rules, action primitives, and coordination protocols for each new environment or objective type. These systems fail when encountering novel objects, unexpected environmental conditions, or objectives that do not fit predefined task templates. Additionally, traditional approaches separate perception, planning, and control into distinct modules with rigid interfaces, creating information bottlenecks that prevent robots from adapting fluidly to dynamic conditions. Accordingly, there is a need for systems and methods to alleviate these and other problems in the art.

### SUMMARY

In some aspects, the techniques described herein relate to a method for orchestrating multiple robots to accomplish an objective in a working environment, the method including: receiving, at a network system, an objective for one or more robots to perform in the working environment; determining, with an orchestration engine, a plurality of actions required to accomplish the objective by: accessing sensor information describing a current state of the working environment, wherein the current state includes spatial and contextual relationships of objects in the working environment; accessing an environment memory, the environment memory including a preferred state of the working environment that defines preferred spatial and contextual relationships of objects in the working environment; applying a model to the sensor information and the environment memory to determine differences between current state and the preferred state; and determining, using the model, the plurality of actions to achieve the preferred state based on the determined differences; orchestrating, with the orchestration engine, the plurality of actions among the one or more robots by: determining skills of each of the one or more robots based on a skill library for that robot; assigning actions from the plurality of actions to the one or more robots based on their skills stored in a skill library; generating an action plan that sequences the assigned actions to achieve the preferred state of the working environment; and transmitting, to each of the one or more robots, their respective assigned actions from the action plan for execution in the working environment, each of the one or more robots perform their assigned task in the working environment.

In some aspects, the techniques described herein relate to a method, wherein each of the one or more robots executes their assigned actions by applying an end-to-end model that directly generates motor commands from sensor information and the assigned actions without explicit decomposition into intermediate symbolic tasks.

In some aspects, the techniques described herein relate to a method, wherein the model applied by the orchestration engine to determine the plurality of actions includes a foundational model trained on large-scale multimodal datasets.

In some aspects, the techniques described herein relate to a method, wherein the environment memory is generated by: receiving sensor information from the one or more robots operating in the working environment; applying a model to the sensor information to identify objects and contextual relationships between objects in the working environment; and encoding the identified objects and contextual relationships into a latent space representation stored as the environment memory.

In some aspects, the techniques described herein relate to a method, wherein the skill library for a first robot of the one or more robots differs from the skill library for a second robot of the one or more robots, and the orchestration engine assigns actions to the first robot and the second robot based on their respective different skill libraries.

In some aspects, the techniques described herein relate to a method, wherein orchestrating the plurality of actions further includes: determining that additional sensor information is needed to coordinate actions between the one or more robots; transmitting a request to at least one of the one or more robots specifying the additional sensor information needed; and receiving the additional sensor information from the at least one robot in response to the request.

In some aspects, the techniques described herein relate to a method, wherein each skill in the skill library represents a capability of a robot to execute actions based on images and task inputs by applying a neural network that directly outputs motor commands to accomplish those actions.

In some aspects, the techniques described herein relate to a non-transitory computer-readable medium storing instructions that, when executed by one or more processors, cause the one or more processors to perform operations including: receiving an objective for one or more robots to perform in a working environment; determining, with an orchestration engine, a plurality of actions required to accomplish the objective by: accessing sensor information describing a current state of the working environment, wherein the current state includes spatial and contextual relationships of objects in the working environment; accessing an environment memory, the environment memory including a preferred state of the working environment that defines preferred spatial and contextual relationships of objects in the working environment; applying a model to the sensor information and the environment memory to determine differences between current state and the preferred state; and determining, using the model, the plurality of actions to achieve the preferred state based on the determined differences; orchestrating, with the orchestration engine, the plurality of actions among the one or more robots by: determining skills of each of the one or more robots based on a skill library for that robot; assigning actions from the plurality of actions to the one or more robots based on their skills stored in a skill library; generating an action plan that sequences the assigned actions to achieve the preferred state of the working environment; and transmitting, to each of the one or more robots, their respective assigned actions from the action plan for execution in the working environment, each of the one or more robots perform their assigned task in the working environment.

In some aspects, the techniques described herein relate to a non-transitory computer-readable medium, wherein each of the one or more robots executes their assigned actions by applying an end-to-end model that directly generates motor commands from sensor information and the assigned actions without explicit decomposition into intermediate symbolic tasks.

In some aspects, the techniques described herein relate to a non-transitory computer-readable medium, wherein the model applied by the orchestration engine to determine the plurality of actions includes a foundational model trained on large-scale multimodal datasets.

In some aspects, the techniques described herein relate to a non-transitory computer-readable medium, wherein the environment memory is generated by: receiving sensor information from the one or more robots operating in the working environment; applying a model to the sensor information to identify objects and contextual relationships between objects in the working environment; and encoding the identified objects and contextual relationships into a latent space representation stored as the environment memory.

In some aspects, the techniques described herein relate to a non-transitory computer-readable medium, wherein the skill library for a first robot of the one or more robots differs from the skill library for a second robot of the one or more robots, and the orchestration engine assigns actions to the first robot and the second robot based on their respective different skill libraries.

In some aspects, the techniques described herein relate to a non-transitory computer-readable medium, wherein orchestrating the plurality of actions further includes: determining that additional sensor information is needed to coordinate actions between the one or more robots; transmitting a request to at least one of the one or more robots specifying the additional sensor information needed; and receiving the additional sensor information from the at least one robot in response to the request.

In some aspects, the techniques described herein relate to a non-transitory computer-readable medium, wherein each skill in the skill library represents a capability of a robot to execute actions based on images and task inputs by applying a neural network that directly outputs motor commands to accomplish those actions.

In some aspects, the techniques described herein relate to a system for orchestrating multiple robots to accomplish an objective in a working environment, the system including: a network system including one or more processors and memory storing instructions that, when executed by the one or more processors, cause the network system to: receive an objective for one or more robots to perform in the working environment; determine, with an orchestration engine, a plurality of actions required to accomplish the objective by: accessing sensor information describing a current state of the working environment, wherein the current state includes spatial and contextual relationships of objects in the working environment; accessing an environment memory, the environment memory including a preferred state of the working environment that defines preferred spatial and contextual relationships of objects in the working environment; applying a model to the sensor information and the environment memory to determine differences between current state and the preferred state; and determining, using the model, the plurality of actions to achieve the preferred state based on the determined differences; orchestrate, with the orchestration engine, the plurality of actions among the one or more robots by: determining skills of each of the one or more robots based on a skill library for that robot; assigning actions from the plurality of actions to the one or more robots based on their skills stored in a skill library; generating an action plan that sequences the assigned actions to achieve the preferred state of the working environment; and transmit, to each of the one or more robots, their respective assigned actions from the action plan for execution in the working environment, each of the one or more robots perform their assigned task in the working environment.

In some aspects, the techniques described herein relate to a system, wherein each of the one or more robots executes their assigned actions by applying an end-to-end model that directly generates motor commands from sensor information and the assigned actions without explicit decomposition into intermediate symbolic tasks.

In some aspects, the techniques described herein relate to a system, wherein the model applied by the orchestration engine to determine the plurality of actions includes a foundational model trained on large-scale multimodal datasets.

In some aspects, the techniques described herein relate to a system, wherein the environment memory is generated by: receiving sensor information from the one or more robots operating in the working environment; applying a model to the sensor information to identify objects and contextual relationships between objects in the working environment; and encoding the identified objects and contextual relationships into a latent space representation stored as the environment memory.

In some aspects, the techniques described herein relate to a system, wherein the skill library for a first robot of the one or more robots differs from the skill library for a second robot of the one or more robots, and the orchestration engine assigns actions to the first robot and the second robot based on their respective different skill libraries.

In some aspects, the techniques described herein relate to a system, wherein orchestrating the plurality of actions further includes: determining that additional sensor information is needed to coordinate actions between the one or more robots; transmitting a request to at least one of the one or more robots specifying the additional sensor information needed; and receiving the additional sensor information from the at least one robot in response to the request.

In some aspects, the techniques described herein relate to a method for updating an environment memory of a working environment in an agentic robot system, the method including: performing, using one or more actuators of a robot, a first action in an action plan to accomplish an objective in the working environment; capturing, by one or more sensors of the robot, sensor information describing the working environment, wherein the sensor information includes at least one or more images of the working environment; generating the environment memory representing the working environment by applying a model to the sensor information, the model configured to: identify contextual and positional information about the working environment and objects in the working environment based on the sensor information; generate a latent space representation of the identified contextual and positional information for the objects and working environment; and store the latent space representation as the environment memory; as the robot performs additional actions in the action plan in the working environment, continuously updating the memory by applying the model to additional sensor information captured by the robot, the continuous updating modifying the latent space representation of the contextual and positional information of the objects and working environment; and performing, using the one or more actuators of the robot, at least one subsequent action in the action plan using the updated memory.

In some aspects, the techniques described herein relate to a method, wherein performing the at least one subsequent action includes: applying an action execution model to the updated memory and current sensor information; and generating motor commands based on the updated memory, the motor commands causing the one or more actuators to perform the at least one subsequent action.

In some aspects, the techniques described herein relate to a method, wherein the action execution model includes a foundational model, and the updated memory provides context to the foundational model by: retrieving relevant portions of the updated memory corresponding to the at least one subsequent action; and providing the retrieved relevant portions as context input to the foundational model along with the current sensor information.

In some aspects, the techniques described herein relate to a method, wherein continuously updating the memory includes: applying the model to the additional sensor information to identify updated contextual and positional information; generating a new latent space representation encoding the updated contextual and positional information; and replacing the latent space representation stored as the environment memory with the new latent space representation.

In some aspects, the techniques described herein relate to a method, wherein continuously updating the memory includes: identifying a relevant portion of the environment memory corresponding to objects affected by the additional actions; applying the model to the additional sensor information to generate an updated latent space representation for the relevant portion; and modifying only the relevant portion of the environment memory with the updated latent space representation.

In some aspects, the techniques described herein relate to a method, wherein performing the at least one subsequent action includes: determining relevant portions of the environment memory needed to perform the at least one subsequent action; requesting the relevant portions from the environment memory; and applying an action execution model to the relevant portions and current sensor information to generate motor commands for performing the at least one subsequent action.

In some aspects, the techniques described herein relate to a method, further including: transmitting the environment memory to a network system over a network; and storing the environment memory in an environmental data store of the network system.

In some aspects, the techniques described herein relate to a method, further including: accessing, by a second robot, the environment memory stored on the network system; and performing, by the second robot, actions in the action plan using the accessed environment memory.

In some aspects, the techniques described herein relate to a method, further including: transmitting a request to a network system for additional memory information; receiving the additional memory information from the network system; and updating the environment memory by merging the additional memory information with the latent space representation.

In some aspects, the techniques described herein relate to a method, wherein performing the at least one subsequent action includes: applying an action execution model to both the environment memory updated by the robot and the additional memory information received from the network system; and generating motor commands based on the combined memory information.

In some aspects, the techniques described herein relate to a non-transitory computer-readable medium storing instructions that, when executed by one or more processors of a robot, cause the robot to perform operations including: performing, using one or more actuators of the robot, a first action in an action plan to accomplish an objective in a working environment; capturing, by one or more sensors of the robot, sensor information describing the working environment, wherein the sensor information includes at least one or more images of the working environment; generating an environment memory representing the working environment by applying a model to the sensor information, the model configured to: identify contextual and positional information about the working environment and objects in the working environment based on the sensor information; generate a latent space representation of the identified contextual and positional information for the objects and working environment; and store the latent space representation as the environment memory; as the robot performs additional actions in the action plan in the working environment, continuously updating the memory by applying the model to additional sensor information captured by the robot, the continuous updating modifying the latent space representation of the contextual and positional information of the objects and working environment; and performing, using the one or more actuators of the robot, at least one subsequent action in the action plan using the updated memory.

In some aspects, the techniques described herein relate to a non-transitory computer-readable medium, wherein performing the at least one subsequent action includes: applying an action execution model to the updated memory and current sensor information; and generating motor commands based on the updated memory, the motor commands causing the one or more actuators to perform the at least one subsequent action.

In some aspects, the techniques described herein relate to a non-transitory computer-readable medium, wherein the action execution model includes a foundational model, and the updated memory provides context to the foundational model by: retrieving relevant portions of the updated memory corresponding to the at least one subsequent action; and providing the retrieved relevant portions as context input to the foundational model along with the current sensor information.

In some aspects, the techniques described herein relate to a non-transitory computer-readable medium, wherein continuously updating the memory includes: applying the model to the additional sensor information to identify updated contextual and positional information; generating a new latent space representation encoding the updated contextual and positional information; and replacing the latent space representation stored as the environment memory with the new latent space representation.

In some aspects, the techniques described herein relate to a non-transitory computer-readable medium, wherein continuously updating the memory includes: identifying a relevant portion of the environment memory corresponding to objects affected by the additional actions; applying the model to the additional sensor information to generate an updated latent space representation for the relevant portion; and modifying only the relevant portion of the environment memory with the updated latent space representation.

In some aspects, the techniques described herein relate to a non-transitory computer-readable medium, wherein performing the at least one subsequent action includes: determining relevant portions of the environment memory needed to perform the at least one subsequent action; requesting the relevant portions from the environment memory; and applying an action execution model to the relevant portions and current sensor information to generate motor commands for performing the at least one subsequent action.

In some aspects, the techniques described herein relate to a non-transitory computer-readable medium, the operations further including: transmitting the environment memory to a network system over a network; and storing the environment memory in an environmental data store of the network system.

In some aspects, the techniques described herein relate to a non-transitory computer-readable medium, the operations further including: accessing, by a second robot, the environment memory stored on the network system; and performing, by the second robot, actions in the action plan using the accessed environment memory.

In some aspects, the techniques described herein relate to a non-transitory computer-readable medium, the operations further including: transmitting a request to a network system for additional memory information; receiving the additional memory information from the network system; and updating the environment memory by merging the additional memory information with the latent space representation.

In some aspects, the techniques described herein relate to a system for updating an environment memory of a working environment, the system including: a robot including: one or more actuators; one or more sensors; one or more processors and memory storing instructions that, when executed by the one or more processors, cause the robot to: perform, using the one or more actuators, a first action in an action plan to accomplish an objective in the working environment; capture, by the one or more sensors, sensor information describing the working environment, wherein the sensor information includes at least one or more images of the working environment; generate an environment memory representing the working environment by applying a model to the sensor information, the model configured to: identify contextual and positional information about the working environment and objects in the working environment based on the sensor information; generate a latent space representation of the identified contextual and positional information for the objects and working environment; and store the latent space representation as the environment memory; as the robot performs additional actions in the action plan in the working environment, continuously update the memory by applying the model to additional sensor information captured by the robot, the continuous updating modifying the latent space representation of the contextual and positional information of the objects and working environment; and perform, using the one or more actuators, at least one subsequent action in the action plan using the updated memory.

In some aspects, the techniques described herein relate to a method for training a robot to perform environment-specific actions, the method including: accessing an environment-agnostic model configured to perform a general action on an object; identifying, using sensor information representing a specific working environment, the object in a specific working environment on which to perform the general action; performing the general action on the object by applying the environment-agnostic model to the sensor information representing the specific working environment; while performing the general action on the object: determining, using sensor information captured while interacting with the object, one or more environment specific parameters used to perform the general action on the object; updating the environment-agnostic model with the one or more environment specific parameters to create an environment-adapted model, the environment-adapted model configured to perform the general action on the object in the specific working environment as an environment aware action using the environment specific parameters; and storing the environment-adapted model in a skill library; and responsive to identifying the object using additional using sensor information representing the specific working environment, accessing the skill library to perform the environment aware action using the environment-adapted model using the environment specific parameters for the object.

In some aspects, the techniques described herein relate to 42. The method, wherein the environment agnostic model includes a neural network trained on large-scale datasets representing diverse environments and objects.

In some aspects, the techniques described herein relate to 43. The method, wherein determining the one or more environment specific parameters includes: capturing force measurements from tactile sensors while the robot interacts with the object; capturing position measurements from the sensors while the robot performs the general action; and analyzing the captured force measurements and position measurements to identify parameters specific to performing the general action on the object in the specific working environment.

In some aspects, the techniques described herein relate to a method, wherein updating the environment agnostic model includes storing a representation of the environment specific parameters for input to a neural network in the environment agnostic model.

In some aspects, the techniques described herein relate to a method, further including: ingesting media including images or videos portraying a skill; training a model to generate motor commands based on the ingested media; and storing the trained model in the skill library as a new skill.

In some aspects, the techniques described herein relate to a method, further including: receiving physical guidance from a user guiding the robot through actions demonstrating a skill; recording sensor information and motor commands during the physical guidance; and training a model to generate motor commands based on the recorded sensor information and motor commands to create a new skill in the skill library.

In some aspects, the techniques described herein relate to a method, further including: participating in federated training of a new skill by training a centralized model using sensor information and motor commands from the robot; receiving the centralized model trained using data from multiple robots in disparate system environments; and adapting the centralized model to the specific working environment to create a new skill in the skill library.

In some aspects, the techniques described herein relate to a non-transitory computer-readable medium storing instructions that, when executed by one or more processors of a robot, cause the robot to perform operations including: accessing an environment agnostic model configured to perform a general action on an object; identifying, using sensor information representing a specific working environment, the object in a specific working environment on which to perform the general action; performing the general action on the object by applying the environment agnostic model to the sensor information representing the specific working environment; while performing the general action on the object: determining, using sensor information captured while interacting with the object, one or more environment specific parameters used to perform the general action on the object; updating the environment agnostic model with the one or more environment specific parameters to create an environment-adapted model, the environment-adapted model configured to perform the general action on the object in the specific working environment as an environment aware action using the environment specific parameters; and storing the environment-adapted model in a skill library; and responsive to identifying the object using additional using sensor information representing the specific working environment, accessing the skill library to perform the environment aware action using the environment-adapted model using the environment specific parameters for the object.

In some aspects, the techniques described herein relate to a non-transitory computer-readable medium, wherein the environment agnostic model includes a neural network trained on large-scale datasets representing diverse environments and objects.

In some aspects, the techniques described herein relate to a non-transitory computer-readable medium, wherein determining the one or more environment specific parameters includes: capturing force measurements from tactile sensors while the robot interacts with the object; capturing position measurements from the sensors while the robot performs the general action; and analyzing the captured force measurements and position measurements to identify parameters specific to performing the general action on the object in the specific working environment.

In some aspects, the techniques described herein relate to a non-transitory computer-readable medium, wherein updating the environment agnostic model includes storing a representation of the environment specific parameters for input to a neural network in the environment agnostic model.

In some aspects, the techniques described herein relate to 52. The non-transitory computer-readable medium, the operations further including: ingesting media including images or videos portraying a skill; training a model to generate motor commands based on the ingested media; and storing the trained model in the skill library as a new skill.

In some aspects, the techniques described herein relate to 53. The non-transitory computer-readable medium, the operations further including: receiving physical guidance from a user guiding the robot through actions demonstrating a skill; recording sensor information and motor commands during the physical guidance; and training a model to generate motor commands based on the recorded sensor information and motor commands to create a new skill in the skill library.

In some aspects, the techniques described herein relate to 54. The non-transitory computer-readable medium, the operations further including: participating in federated training of a new skill by training a centralized model using sensor information and motor commands from the robot; receiving the centralized model trained using data from multiple robots in disparate system environments; and adapting the centralized model to the specific working environment to create a new skill in the skill library.

In some aspects, the techniques described herein relate to a system for training a robot to perform environment-specific actions, the system including: a robot including: one or more actuators; one or more sensors; and one or more processors and memory storing instructions that, when executed by the one or more processors, cause the robot to: access an environment agnostic model configured to perform a general action on an object; identify, using sensor information representing a specific working environment, the object in a specific working environment on which to perform the general action; perform the general action on the object by applying the environment agnostic model to the sensor information representing the specific working environment; while performing the general action on the object: determine, using sensor information captured while interacting with the object, one or more environment specific parameters used to perform the general action on the object; update the environment agnostic model with the one or more environment specific parameters to create an environment-adapted model, the environment-adapted model configured to perform the general action on the object in the specific working environment as an environment aware action using the environment specific parameters; and store the environment-adapted model in a skill library; and responsive to identifying the object using additional using sensor information representing the specific working environment, access the skill library to perform the environment aware action using the environment-adapted model using the environment specific parameters for the object.

In some aspects, the techniques described herein relate to a system, wherein the environment agnostic model includes a neural network trained on large-scale datasets representing diverse environments and objects.

In some aspects, the techniques described herein relate to a system, wherein determining the one or more environment specific parameters includes: capturing force measurements from tactile sensors while the robot interacts with the object; capturing position measurements from the sensors while the robot performs the general action; and analyzing the captured force measurements and position measurements to identify parameters specific to performing the general action on the object in the specific working environment.

In some aspects, the techniques described herein relate to a system, wherein updating the environment agnostic model includes storing a representation of the environment specific parameters for input to a neural network in the environment agnostic model.

In some aspects, the techniques described herein relate to a system, the instructions further causing the robot to: ingest media including images or videos portraying a skill; train a model to generate motor commands based on the ingested media; and store the trained model in the skill library as a new skill.

In some aspects, the techniques described herein relate to 60. The system, the instructions further causing the robot to: receive physical guidance from a user guiding the robot through actions demonstrating a skill; record sensor information and motor commands during the physical guidance; and train a model to generate motor commands based on the recorded sensor information and motor commands to create a new skill in the skill library.

### BRIEF DESCRIPTION OF DRAWINGS

Figure (“FIG.”) 1 is a block diagram of a system environment for a system that coordinates an agentic robot, according to one example embodiment.

FIG. 2A is block diagram of a robot, according to one example embodiment.

FIG. 2B is a block diagram of a network system, according to one example embodiment.

FIG. 2C is block diagram of a user device, according to one example embodiment.

FIG. 3 shows a block diagram of an agentic robot control ecosystem, according to one example embodiment.

FIG. 4 is a workflow diagram for orchestrating multiple robots to accomplish an objective in a working environment, according to an example embodiment.

FIG. 5 is a workflow diagram for updating an environment memory of a working environment in an agentic robot system, according to an example embodiment.

FIG. 6 is a workflow diagram for training a robot to perform environment-specific actions, according to an example embodiment.

FIG. 7 is a block diagram illustrating components of an example machine for reading and executing instructions from a machine-readable medium, according to an example embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Introduction

Coordinating multiple robots to accomplish complex objectives in dynamic environments presents significant technical challenges. Translating raw sensor information into actionable representations that multiple robots can use requires computationally intensive processing of high-dimensional data streams. Training robots to acquire new skills for environment-specific tasks demands substantial data collection and model adaptation. Coordinating actions between robots with different mechanical configurations, sensor modalities, and processing capabilities introduces synchronization and communication overhead that can limit system responsiveness.

Previous approaches to multi-robot coordination have relied on explicit symbolic planning systems that decompose objectives into predefined task hierarchies. These systems require manual specification of task decomposition rules, action primitives, and coordination protocols for each new environment or objective type. Such approaches fail when encountering novel objects, unexpected environmental conditions, or objectives that do not fit predefined task templates. Additionally, traditional systems separate perception, planning, and control into distinct modules with rigid interfaces, creating information bottlenecks that prevent robots from adapting fluidly to dynamic conditions. The computational overhead of maintaining explicit symbolic representations and performing discrete planning steps limits the ability of these systems to operate in real-time.

Foundational models trained on large-scale multimodal datasets enable a fundamentally different approach to robot coordination. These models learn generalizable representations that capture visual, semantic, and language information in a unified framework. By processing sensor information through learned representations rather than explicit symbolic structures, foundational models can generate appropriate actions for novel objects and environments without requiring manual specification of task decomposition rules. The models encode contextual relationships and spatial understanding that allow robots to interpret objectives expressed in natural language and map them to appropriate motor commands. This context-aware processing enables robots to adapt their behavior based on environmental conditions and coordinate actions based on learned patterns rather than rigid protocols.

Distributing processing between on-edge computation at individual robots and cloud-based computation at a network system provides technical advantages for multi-robot coordination. On-edge processing enables low-latency generation of motor commands by applying models directly on robot processors, allowing rapid response to sensor information without network communication delays. Cloud-based processing provides access to larger computational resources for complex tasks such as generating action plans that coordinate multiple robots, processing high-resolution sensor information from multiple sources, and maintaining shared memory representations of the working environment. The system can dynamically allocate processing based on task complexity, available computational resources, and latency requirements.

The disclosed system addresses these technical challenges through several coordinated mechanisms. The orchestration engine generates action plans by applying models to sensor information and environment memory to determine differences between current and preferred states of the working environment. The models process visual information captured by robot sensors to generate latent space representations encoding spatial layouts, object arrangements, and contextual relationships. These latent representations serve as a compressed memory that multiple robots can access to coordinate their actions without requiring explicit symbolic communication of environmental state. The system assigns actions to robots based on skill libraries that define each robot's capabilities, allowing heterogeneous robots with different mechanical configurations to collaborate on complex objectives.

The environment memory system continuously updates latent space representations as robots perform actions in the working environment. Models applied to sensor information identify contextual and positional information about objects and encode this information into embeddings that capture learned patterns and relationships. The continuous updating modifies the latent representations to reflect changes in object positions, spatial relationships, and environmental conditions as robots execute actions. Subsequent actions are performed using the updated memory, allowing robots to adapt their behavior based on the current state of the environment without requiring explicit re-planning.

The environment-adaptive training system enables robots to specialize foundational capabilities for specific working environments. Robots access environment-agnostic models representing general skills learned through large-scale training, perform actions using these models, and determine environment-specific parameters such as required forces, motion paths, or timing based on sensor information captured during execution. The system updates the environment-agnostic models with the determined parameters to create environment-adapted models that perform actions more efficiently in the specific working environment. These environment-adapted models are stored in skill libraries and accessed when robots subsequently encounter the same objects or conditions.

The disclosed system provides a technical solution to the technical problem of coordinating multiple heterogeneous robots to accomplish complex objectives in dynamic environments. The system improves robot operation by generating motor commands based on learned representations that encode spatial, contextual, and semantic information about the working environment, rather than relying on manually specified symbolic planning rules. The continuous updating of environment memory based on sensor information captured during action execution enables robots to adapt their behavior to changing environmental conditions in real-time. The environment-adaptive training mechanism improves robot performance by determining environment-specific parameters during action execution and incorporating those parameters into models that generate motor commands for subsequent actions. These technical improvements enable robots to accomplish objectives more efficiently than a traditional system.

### System Environment

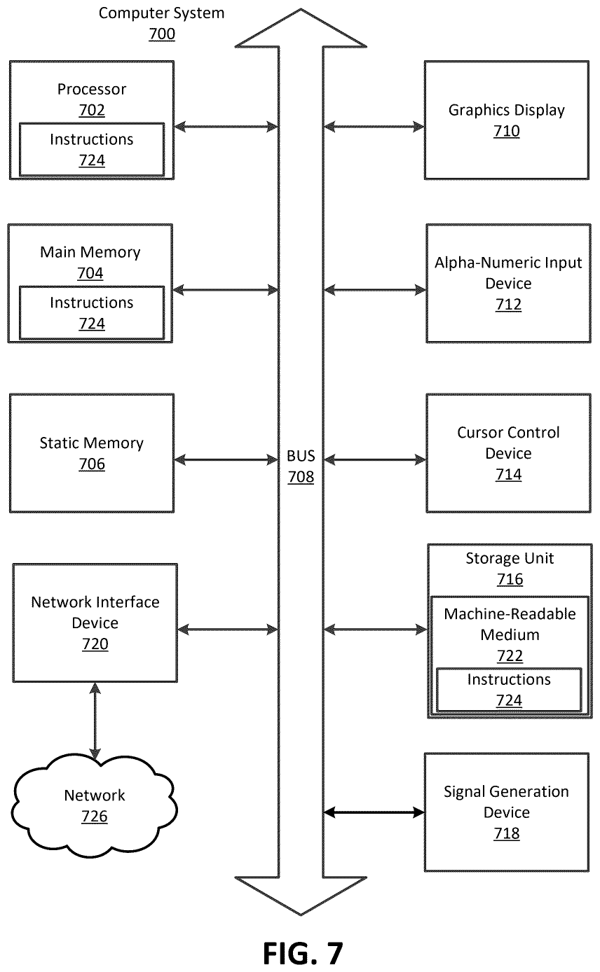

FIG. 1 is a block diagram of a system environment for a system that coordinates an agentic robot, according to one example embodiment. The system environment 100 includes a working environment 110, a first agentic robot 120A (“robot 120” or “robot 120A”), a second agentic robot 120B (“robot 120” or “robot 120B”), a network 150, a network system 130, and a user device 140. In alternative configurations, different and/or additional components may be included in the system environment 100. The computing systems of the system environment 100 may include some or all of the components (systems (or subsystems)) of a computer system 700 as described with FIG. 7. In some embodiments, the computing devices may be configured with software to function as described herein. For example, program code comprised of instructions may cause a processing system to be structured in a manner so that the device operates the specific functionality upon execution of the program code.

To begin, a general description of coordinating robots (e.g., robot 120A, 120B, etc.) for completing an objective within the system environment 100 is provided. Within the environment, there are several methodologies for identifying objectives. For instance, a user of a user device 140 may identify an objective for one or more robots 120 in the working environment 110 to perform, a robot 120 may identify an objective in the working environment 110 (e.g., based on sensor information), and a robot 120 and a user may act together to identify an objective in the working environment 110 (e.g., robot querying a user about an objective or for guidance in identifying or confirming an objective), etc.

An objective is some goal for the robots 120 to accomplish in the working environment 110. The robot accomplishes the objective by performing one or more tasks and/or actions. Typically, an objective is something that aids or assists the user may in some way within the working environment 110. The tasks and/or actions are the various machine actions the robots perform to accomplish that objective. For example, an objective may be picking up a box, cleaning a room, doing the laundry, mopping the floor, etc. The tasks and/or actions may include, using picking up a box as an example, moving towards the box, articulating the robot 120 to grab the box, and articulating the robot to lift the box.

Within this context there are various methods implementing objective based task and action coordination for a robot 120.

In a first example, the system environment 100 may employ an end-to-end methodology. In an end-to-end approach, the robot 120 receives sensor information (e.g., images of the working environment 110) and an objective as inputs, and a model directly outputs motor commands or joint actions to accomplish that objective without explicitly decomposing the objective into intermediate symbolic tasks or sub-tasks. The model processes the sensor information and objective through learned representations to generate the physical actions required for the robot 120 to achieve the objective.

In a second example, the system environment 100 may employ a hierarchical task decomposition methodology. In this approach, each objective may include a set of tasks (“task set”) that the robot(s) 120 must perform to accomplish the objective. For instance, cleaning up a room may include, e.g., a robot 120A picking up items from the floor, a robot 120B vacuuming the floor, both robots 120A, 120B making the bed, etc.

Additionally, the complexity of an objective may vary significantly. For example, the objective of picking up a box is less complex than the objective of cleaning a room. Taking this into account, an objective may also be represented as a hierarchy of tasks and sub-tasks (and sub-sub-tasks, etc.). This allows one or more robots in the environment to coordinate different tasks for a similar objective. So, again taking the room cleaning as an example, the task of making the bed may include sub tasks of positioning the top-sheet, positioning the comforter, and positioning the pillows. In turn, each of those sub-tasks may include their own sub-tasks. The robot may then perform the necessary machine action to perform the tasks to accomplish the objective.

In a third example, the system environment 100 may employ a further hierarchical breakdown of tasks into action sets. In this approach, each task identified to accomplish the objective may include a corresponding set of actions (“action set”). The action set represents the series of mechanical movements the robot 120 performs to accomplish the task, which aids in achieving the objective. For instance, the task of “pick up a toy” may include actions such as “move arm to toy location,” “open gripper,” “grasp toy,” and “lift toy.” Each action in the action set represents a specific mechanical movement that, when performed in sequence, accomplish the task and/or objective.

In various configurations, the system environment 100 may employ any combination of the methodologies described above to accomplish objectives. The particular combination employed may depend on factors such as the complexity of the objective, the capabilities of the robot 120, the processing resources available, and the nature of the working environment 110. For instance, the system may use an end-to-end approach for certain straightforward tasks while simultaneously employing hierarchical task decomposition for more complex aspects of the same objective. As a first example, a robot 120 may use an end-to-end methodology to generate motor commands for navigating through a room, while using hierarchical task decomposition to coordinate the higher-level objective of “clean the kitchen” into tasks such as “clear the table,” “load the dishwasher,” and “wipe the counters.” As a second example, the system may employ an end-to-end approach to directly generate motor commands for grasping objects, while using a hierarchical breakdown into action sets for the task of “organize the bookshelf,” where each organizing task is decomposed into specific actions like “identify book,” “grasp book,” “move to shelf location,” and “place book.”

Therefore, overall, accomplishing an objective in the system environment 100 includes generating a series of actions that the robot 120 performs in the working environment 110. More particularly, the objective action series is a sequence of actions that, when performed, accomplish the objective. The actions in the objective action series may be generated in an end-to-end manner, a hierarchical manner, or some combination thereof. Once identified, elements in the system environment 100 act in conjunction to instruct the robot(s) 120 to perform the actions in the objective action series to achieve the objective in the working environment 110 (e.g., network system 130, processors of agentic robot 120, etc.).

Within the system environment 100, some combination of the robot 120, the network system 130, and the user device 140 are used to identify and generate the objective action series. Which systems in the system environment 100 are employed depend on the capability of each of those systems and the complexity of the objective.

To illustrate, consider, as an example, a user inputting an objective of “putting laundry in a hamper.” In this case, a control system of a robot 120 has sufficient processing power and capability to identify clothing in the working environment 110, pick up the clothing, and place that clothing in the hamper. The robot 120 may use an end-to-end approach to generate the objective action series directly from sensor information. On the other hand, consider, as an example, a user inputting an objective of “clean up the house.” In this case, the processor of the robot 120 may not have sufficient capability to generate the objective action series for this objective, and the robot 120 may leverage the network system 130 to assist (by either the robot 120 requesting the network system 130 to assist, or the network system 130 determining it should assist). The network system 130 may generate the objective action series using a hierarchical approach and instruct one or more robots 120 to perform the actions in that series. The robot 120 may then execute the actions to accomplish the objective.

For instance, referring again to the house cleaning example, the network system 130 may generate an objective action series that includes actions such as, e.g., collect items from the master bedroom, collect items from the children's bedroom, sort items by type, clean surfaces, vacuum floors, and organize items. The network system 130 may then sequentially instruct the robot(s) 120 to perform the actions in the objective action series.

As mentioned above, the line between generating actions at a robot 120 level and at a network level can vary depending on the system environment 100. For example, system environments may have robots 120 with varying levels of capability (e.g., a first generation robot, and a fifth generation robot), working environments 110 may have different levels of complexity, objectives may have different levels of complexity, etc. The system environment 100 considers these variations when generating the objective action series, and may employ end-to-end, hierarchical, or combined approaches accordingly.

The description now turns to a more robust description of each element in the system environment 100. A working environment 110 is a workspace of the robot 120. The working environment 110 may include multiple robots 120, and each robot 120 may be equipped with different modalities tailored to specific objectives within the environment. The working environment 110 may be different types of environments such as, e.g., a residential setting, a commercial setting, or an industrial setting. The residential setting may be a room, kitchen, laundry room, etc. The commercial setting may be a restaurant, a laundromat, an office space, etc. The industrial setting may include, e.g., an assembly line, a construction site, etc. More generally, the working environment 110 is a functional space where robots 120 operate autonomously or in coordination.

The working environment 110 may include a sensor network. As an example, the sensor network may be a camera system including sensors that monitor the working environment 110. Thus, the sensor network may provide additional information about the working environment 110 to robots 120, the network system 130, or the user device 140. The provided sensor information enables the robots 120 to autonomously adapt to dynamic changes within the working environment 110, ensuring safe, efficient, and context-aware operation of the robots 120. In some cases, as described below, each robot 120 in the working environment 110 serves as a sensor in the sensor network. That is, each robot 120 may include sensors (e.g., a camera) from which sensor information (e.g., images) can be received, and the system environment 100 may process that information to accomplish objectives in the working environment 110.

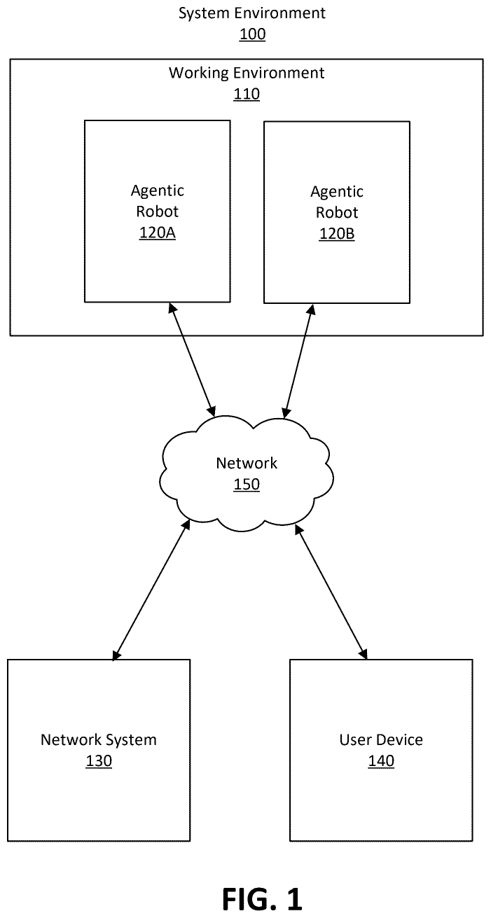

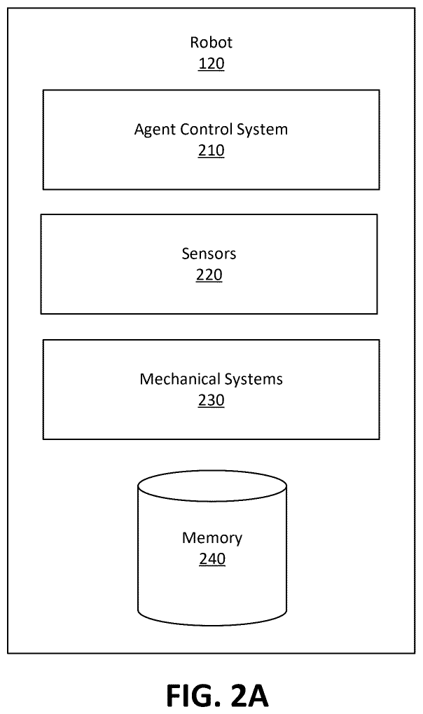

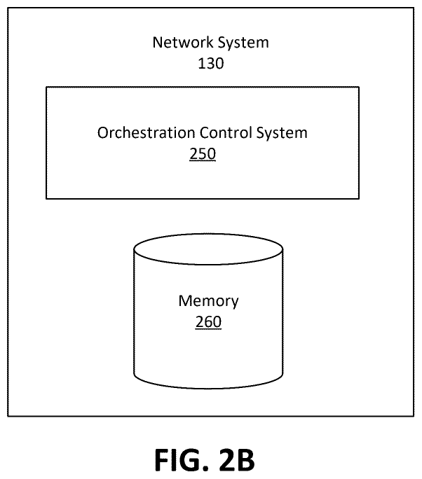

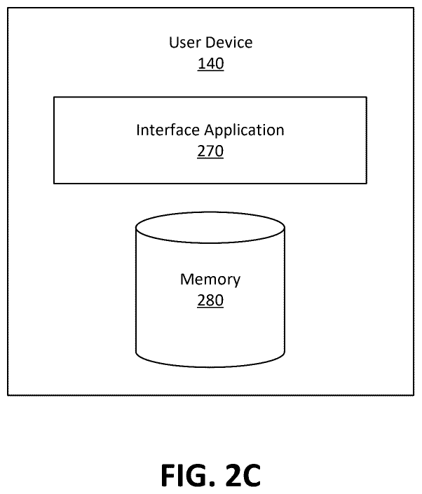

A working environment 110 in the system environment 100 includes one or more robots 120A, 120B, etc. Each robot 120 is designed with distinct capabilities, such as mobility, manipulation, sensing, communication, etc. The capabilities of a robot 120 are configured for the actions required within the working environment 110 and each robot 120 may be differently configured. For instance, a first robot 120A may have advanced navigation and obstacle avoidance for transporting objects within the working environment 110, while a second robot 120B may include specialized arms for handling delicate items or performing precise actions like cooking or folding laundry. To accomplish objectives, the robot 120 includes one or more processors executing one or more models and/or control algorithms. The models and/or control algorithms, at the most granular level, take in sensor information as input and output machine commands representing actions for the robot 120 to execute. The models and/or control algorithms may generate these actions using an end-to-end approach, a hierarchical approach, or some combination thereof. The robot 120 is further described in FIG. 2A.

The system environment 100 includes a network system 130. The network system 130 assists in generating the objective action series within the working environment 110. To that end, the network system 130 includes one or more processors executing one or more algorithms and/or models to do so. As an example, the network system 130 may receive information describing the working environment 110 from one or more robots 120. The network system 130 applies a model to that information, and the model generates the objective action series to perform in the working environment 110 to accomplish a user-defined objective. The objective action series may be generated using an end-to-end approach, a hierarchical approach, or some combination thereof. The network system 130 transmits the actions from the objective action series to the robot 120, and the robot 120 performs those actions in the working environment 110. In other words, the network system 130 aids in complex compute tasks, such as action prioritization, resource allocation, and inter-robot 120 coordination.

The user device 140 operates as an interface point between a user and the other elements in the system environment 100. Typically, user device 140 is a computing device such as, e.g., a cellular phone, a laptop, or a personal computer. Whatever the configuration, the user device 140 displays information to users, receives information from users, and communicates information to other elements of the system environment 100. For example, the user device 140 may display the location of robots 120 in the working environment 110, receive an objective from the user based on the displayed information, and transmits that objective to the robot 120 or network system 130, as appropriate. While one user device 140 is illustrated in FIG. 1, the system environment 100 may include any number of user devices 140. In an embodiment, user devices 140 may include some or all the components (systems (or subsystems)) of a computer system 700 as described with FIG. 7.

The system environment 100 includes a network 150. The network 150 communicatively couples the working environment 110, the robots 120A, 120B, a network system 130, and the user device 140, and the components through one or more sub-networks, which may include any combination of the local area and/or wide area networks, using both wired and/or wireless communication systems. In one embodiment, a network 150 uses standard communications technologies and/or protocols. For example, a network 150 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 150 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 150 may be represented using any suitable format, such as hypertext markup language (HTML), extensible markup language (XML), JavaScript object notation (JSON), structured query language (SQL). In some embodiments, all or some of the communication links of a network 150 may be encrypted using any suitable technique or techniques such as secure sockets layer (SSL), transport layer security (TLS), virtual private networks (VPNs), Internet Protocol security (IPsec), etc. The network 150 also includes links and packet switching networks such as the Internet.

### Agentic Robot

FIG. 2A is block diagram of a robot, according to one example embodiment. A robot 120 may include an agent control system 210 (“control system 210”), one or more sensors 220, one or more mechanical systems 230, and a memory 240 (which may be a database in some embodiments). The robot 120 may include additional or fewer systems, and/or functionality of various systems of the robot 120 may be attributable to one or more different systems in the system environment 100.

The robot 120 includes an agent control system 210. The control system 210 is the central processing system of the robot 120 that generates the objective action series and executes the actions in that series. To do so, the control system 210 inputs information describing the working environment 110 and applies various models and control algorithms to that information to generate actions to perform, and causes the robot 120 to perform those actions. The control system 210 may generate the objective action series using an end-to-end approach, a hierarchical approach, or some combination thereof. For example, the control system 210 may input various information representing the working environment 110 and the agentic robot (e.g., an image or sequence of images of the working environment 110 from the sensor system 220, a current state of the robot, a previous state of the robot 120, previous actions of the robot 120, etc.) and apply a model to that information. Using images as an example, the image sequences may be a video input including current and past images, or the image sequence may be a series of images representing an “imagined” future (e.g., images representing a possible future state or states of the robot). The model generates the objective action series based on the information in the image. The control system 210 then generates machine commands that mechanical systems 230 execute to perform the actions in the objective action series to accomplish the objective. Description of using robot information such as current state, previous state, etc. are provided below. Additionally, more aspects of the control system 210 are described in greater detail hereinbelow.

The robot 120 includes one or more sensors 220. The sensors 220 provide real-time information to the control system 210. The information may include information describing the working environment 110, mechanical systems 230, the system environment 100, etc. The sensors 220 may include vision sensors (e.g., cameras), proximity sensors (e.g., LiDAR, infrared), tactile sensors (e.g., pressure or force sensors), etc. These sensors 220 allow the robot 120 to perceive its surroundings, detect obstacles, monitor the status of objects, and interact safely with the environment. To accomplish objectives, data from the sensors 220 are fed to the control system 210 and that information is processed to generate the objective action series. The generated actions allow the robot 120 to respond and adapt to a dynamic environment. In some cases, the sensor information may be passed to a network system 130.

The robot 120 includes one or more mechanical systems 230. A mechanical system 230 is a set of mechanical components (e.g., actuators) that allow the robot 120 to interact with the working environment 110. The mechanical systems 230 consist of various actuators, motors, and other components that allow the robot 120 to physically manipulate objects, navigate the working environment 110, or perform specific actions (e.g., folding laundry, doing dishes, etc.). This may include robotic arms for picking and placing objects, wheels or legs for mobility, and grippers, multiple fingered hands or specialized tools for interacting with different surfaces or materials. The mechanical systems 230 work in conjunction with the control system 210 to execute the actions in the objective action series. Some of the mechanical systems 230 are descried in greater detail hereinbelow.

The robot 120 includes a memory 240. The memory 240 stores information pertaining to the robot 120, the working environment 110, action operation settings, robot 120 machine settings and parameters, the system environment 100, past observations, user preferences, past robot actions, past use demonstrations, environment parameters (e.g., object information from the working environment 110), etc. As an example, the memory 240 may store a setting or robot 120 configuration for performing an action such as picking up an item from the floor. Further, the robot 120's memory may also store computer program code for executing on a processor to generate the objective action series in the environment.

To provide a contextual example of robot 120 functionality, the robot 120 performs actions to accomplish an objective within the working environment 110. That is, upon receiving instructions from the user device 140 to perform a user-defined objective (or from the network system 130), the robot 120 utilizes the sensors 220 to collect contextual information from the environment, such as object locations, spatial constraints, and other objective-relevant data. The control system 210 processes that information to generate the objective action series to accomplish that objective. The robot 120 generates the appropriate machine commands to execute the actions that, when performed in aggregate, accomplish the objective. The control system 210 then causes the mechanical systems 230 to execute the machine commands to perform the actions.

Additionally, as noted above, coordinating actions between robots 120 may cause some of the information processing to occur on the network system 130. In this case, the network system 130 may process information received from the robot 120 and generate the objective action series to perform a user-defined objective. For instance, the network system 130 may receive sensor data 220, process the received data to generate the objective action series for the robots 120, and transmit the actions from the objective action series to the robots 120 to accomplish the user-defined objective. Through a continuous exchange of instructions, environmental data, and coordination updates, the robots 120 and network system 130 may effectively work together to accomplish complex objectives in the working environment 110. For instance, network system 130 may provide an action list (to accomplish an objective) to a robot 120. Lower level systems and models on the robot 120 execute instructions on the action list. Depending on the actions of the action list, network system 130 may occasionally intervene to update the instructions for the robot 120.

### Network System

The system environment 100 includes a network system 130. FIG. 2B is a block diagram of a network system, according to one example embodiment. A network system 130 may include an orchestration control system 250 and a memory 260. The network system 130 may include additional or fewer systems, and/or functionality of various systems of the network system 130 may be attributable to one or more different systems in the system environment 100.

The network system 130 includes an orchestration control system 250 (“orchestration system”). The orchestration system 250 is the central processing system of the network system 130 and assists the robot 120 in generating the objective action series and execute the actions in that series. To do so, the orchestration system 250 inputs information describing the working environment 110 and applies various models and control algorithms to that information to generate actions in the environment based on a user-defined objective. The orchestration system 250 may generate the objective action series using an end-to-end approach, a hierarchical approach, or some combination thereof. Subsequently, the network system 130 may instruct or cause the robot 120 to perform the actions. For example, the orchestration system 250 may input an image of the working environment 110 from a sensor system 220 of the robot 120 and apply a model to that image. The model generates actions to be performed in the working environment 110 based on the information in the image and the user-defined objective. The orchestration system 250 then applies a model to plan how the robot 120 will implement those actions to accomplish the objective. The orchestration system 250 then transmits the actions to robots 120 and instructs those robots 120 to execute those actions.

The network system 130 includes a memory 260. The memory 260 stores information pertaining to the robot 120, the working environment 110, action operation settings, user preferences, robot 120 machine settings and parameters, the system environment 100, etc. As an example, the memory 260 may store a setting or robot 120 configuration for performing an action such as arranging shoes in a specific order. Further, the memory 260 may also store computer program code for executing a model on a processor to generate the objective action series in the environment.

### User Device

The system environment 100 includes a user device 140. FIG. 2C is block diagram of a user device 140, according to one example embodiment. A user device 140 may include a robot interface application 270 and memory 280. The user device 140 may include additional or fewer systems, and/or functionality of various systems of the user device 140 may be attributable to one or more different systems in the system environment 100. The user device may be embodied by a computer system as illustrated in FIG. 7.

As described above, the user device 140 is a computing device through which a user may interact with the robots 120 and the network system 130 via the network 150. The user device 140 can be a personal or mobile computing device, such as a smartphone, a tablet, a laptop computer, or desktop computer. In some embodiments, the user device 140 executes an application that uses an application programming interface (API) to communicate with the network system 130 and/or the robot 120.

The user device 140 includes a robot 120 interface application 270 (“application”). The application 270 is configured to enable seamless communication between the user device 140 and the network system 130. The application 270 may include an Application Programming Interface (API) that facilitates the transmission and reception of commands between the user device 140 and the robot 120, and/or the user device 140 and the network system 130. Through this API, the user device 140 can send operational instructions (e.g., a user-defined objective) to the robot 120 or network system 130 and receive real-time system feedback from the user.

The user device 140 includes the memory 280 to store information relevant to the coordination of robots 120 to perform actions. The information may include, e.g., user settings, robot 120 machine settings and parameters, passwords, and information related to the user, information related to the working environment 110, etc.

### Agentic Robot Control Framework

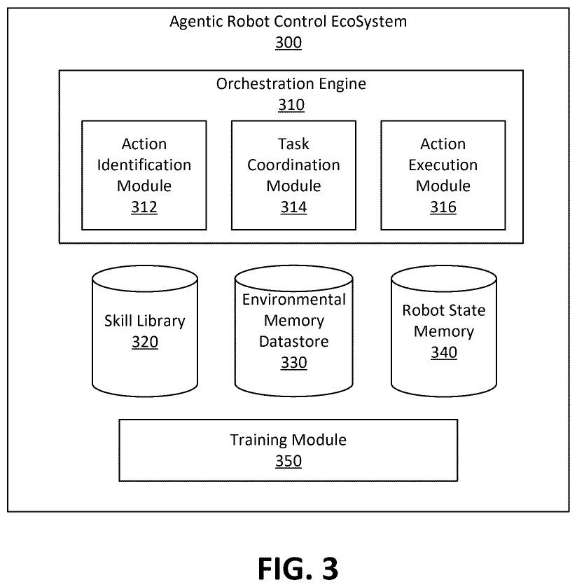

The description now turns to a more in-depth discussion of generating the objective action series. To illustrate these concepts, FIG. 3 shows a block diagram of an agentic robot control ecosystem, according to one example embodiment. The agentic robot control ecosystem 300 (“control ecosystem 300”) includes an orchestration engine 310. The control ecosystem 300 may also include several databases such as, e.g., a skill library 320, an environmental memory data store 330, and state memory 340. Moreover, the control ecosystem 300 includes a training module 350. The control ecosystem 300 may include additional or fewer elements, and/or functionality of various systems of the control ecosystem 300 may be attributable to one or more different systems in the system environment 100.

At a high level, the control ecosystem 300 utilizes data received from a robot 120 (e.g., sensor measurements, images, etc.) and instructions received from a user device 140 (e.g., a user-defined objective) to generate the objective action series for one or more robots 120 in a working environment 110 to accomplish the objective. Importantly, various elements of the control ecosystem 300 may reside on different or the same systems within the system environment 100, depending on the situation. So, for instance, a robot 120 may include an action execution module 316 (e.g., in a control system 210), while a network system 130 may include an objective processing module 312 and an action execution module 314 (e.g., in an orchestration system 250). Other examples are also possible. For instance, in some cases, both a robot 120 and a network system 130 may include objective processing module 312 and action execution module 314.

To illustrate the distribution of processing, consider an example where a robot 120 performs most processing on-edge and uses the network system 130 only to receive information specific to a task that is not available locally. For instance, a robot 120 operating in a residential working environment 110 may be performing routine cleaning tasks using its control system 210 to generate the objective action series and execute actions. The robot 120 applies models locally to sensor information captured by its sensors 220 to identify objects, generate actions, and produce motor commands for its mechanical systems 230.

However, when an external event occurs (e.g., a package being delivered to the front door) the robot 120 may not have direct sensor access to detect this event. In this case, the network system 130 receives notification from an external system (e.g., a delivery service API or a doorbell camera system) indicating that a package has arrived. The network system 130 transmits this specific information to the robot 120, and the robot 120 incorporates this information into its local processing to generate a new objective action series that includes retrieving the package. The robot 120 continues to perform all action generation and motor command generation on-edge, with the network system 130 serving only as a conduit for external information that the robot 120 could not obtain through its own sensors.

Conversely, consider an example where the network system 130 performs coordination and action identification, then transmits those actions to robots 120 for on-edge execution. In a scenario where multiple robots 120A, 120B are tasked with a complex objective such as “prepare the house for guests,” the network system 130 receives this high-level objective from a user device 140. The orchestration system 250 of the network system 130 accesses sensor information from multiple robots 120 throughout the house, retrieves environment memory from the environmental memory data store 330, and applies models to generate a comprehensive objective action series. The orchestration system 250 identifies actions such as “clean the living room,” “organize the kitchen,” “tidy the bathrooms,” and “arrange the dining area,” and assigns these actions to different robots 120 based on their skill libraries 320 and current positions.

The network system 130 generates an action plan that sequences these actions and transmits the assigned actions to each robot 120. Each robot 120 receives its assigned actions and performs all subsequent processing on-edge. That is, the control system 210 of each robot 120 applies action execution models to local sensor information to generate motor commands, and the mechanical systems 230 execute those commands to perform the actions. The robots 120 may periodically transmit status updates to the network system 130, and the network system 130 may adjust the action plan if needed, but the generation of motor commands and execution of actions occurs entirely on-edge at each robot 120.

The distribution of processing between on-edge computation at individual robots and cloud-based computation at the network system depends on various factors in the system environment 100. The computational architecture is dynamically determined based on the specific characteristics of the objective, the capabilities of available robots 120, the constraints of the working environment 110, etc.

One factor influencing the distribution is the complexity of the objective. Simple objectives such as “pick up a toy” may be accomplished entirely through on-edge processing where the robot 120 applies models locally to generate motor commands. Complex objectives such as “prepare the house for guests” may require cloud-based processing where the network system 130 decomposes the objective into coordinated actions across multiple robots 120. The network system 130 may handle high-level planning and coordination while robots 120 handle low-level motor command generation.

One factor influencing the distribution is the processing capability of individual robots 120. Robots 120 with advanced processors and sufficient memory may perform more processing on-edge, including applying large models to generate action plans and motor commands. Robots 120 with limited processing resources may offload complex computations to the network system 130 and receive pre-computed action plans for execution. The system environment 100 may include heterogeneous robots 120 with different processing capabilities, and the distribution of processing is adapted for each robot based on its capabilities.

One factor influencing the distribution is the latency requirements of actions. Actions requiring rapid response to sensor information, such as obstacle avoidance or real-time manipulation, are typically processed on-edge to minimize communication delays. Actions that can tolerate higher latency, such as long-term planning or coordination between distant robots 120, may be processed on the network system 130. The system dynamically allocates processing based on the temporal constraints of each action in the objective action series.

One factor influencing the distribution is the availability and reliability of network connectivity. In working environments 110 with consistent high-bandwidth network connections, more processing may be offloaded to the network system 130 to leverage greater computational resources. In working environments 110 with intermittent or limited network connectivity, robots 120 perform more processing on-edge to maintain autonomous operation when network communication is unavailable. The system may adaptively shift processing between on-edge and cloud-based based on current network conditions.

One factor influencing the distribution is the need for coordination between multiple robots 120. Objectives requiring tight coordination between robots 120, such as jointly manipulating large objects or performing synchronized actions, may utilize cloud-based processing where the network system 130 generates coordinated action plans. Objectives where robots 120 operate independently may utilize on-edge processing where each robot 120 generates its own action plan without requiring coordination through the network system 130.

One factor influencing the distribution is the size and complexity of models required for action generation. Large models that exceed the memory or processing capacity of individual robots 120 may be hosted on the network system 130, with robots 120 transmitting sensor information to the network system 130 and receiving generated actions in return. Smaller models that fit within robot resources may be deployed on-edge for faster processing without network communication overhead.

### Other Examples are Also Possible

With this context, the orchestration engine 310 coordinates robots 120 in the working environment 110 to accomplish user-defined objectives within the operating environment 110. This process includes receiving and processing objectives, generating the objective action series using an end-to-end approach, a hierarchical approach, or some combination thereof, and generating machine instructions that cause the robot(s) 120 to execute the actions in the objective action series.

### Objective Identification and Action Set Execution Using Memory

The orchestration engine 310 includes an action identification module 312. The action identification module 312 receives an objective and generates an objective action series to accomplish that objective. The objective may be received from a user device 140, accessed from a network system 130, or identified by the robot 120 itself based on sensor information from the working environment 110. The objective may be an active directive to perform a specific task in the moment (e.g., “pick up the toys in the bedroom”) or a standing directive to maintain a particular state in perpetuity (e.g., “keep the room clean”).

To accomplish the objective, the action identification module 312 inputs images of the working environment 110, applies an action identification model to those images, and generates the objective action series. The action identification model processes the images along with the objective to determine what actions the robot 120 should perform to accomplish the objective. The action identification model may be a visual language model (“VLM”), a large language model, a large multimodal model (“LMM”), or some other model trained to generate actions based on multi-modal input. The action identification model may also be some combination of models.

The action identification module 312 may generate the objective action series using an end-to-end approach. In an end-to-end approach, the action identification model directly outputs motor commands or joint actions from the images and objective without explicitly decomposing the objective into intermediate symbolic tasks or sub-tasks. For example, given images of a bedroom with toys on the floor and an objective to “pick up the toys,” the action identification model may directly generate motor commands that cause the robot 120 to navigate to a toy, articulate its arm to grasp the toy, lift the toy, navigate to a toy bin, and place the toy in the bin.

Alternatively, the action identification module 312 may generate the objective action series using a hierarchical approach. In a hierarchical approach, the action identification model decomposes the objective into a hierarchy of tasks, sub-tasks, and actions before generating motor commands. For example, given bedroom images and a higher-level objective to “clean up the room,” the action identification model may first identify high-level tasks such as “organize toys,” “organize closet,” and “tidy other items.” The “organize toys” task may then be decomposed into sub-tasks such as “collect toys from floor,” “transport toys to bin,” and “place toys in bin.” Similarly, the “organize closet” task may be decomposed into sub-tasks such as “arrange hanging items,” “fold and stack clothing,” and “close closet door.” Each of these sub-tasks may then be further decomposed into actions, such as “navigate to toy location,” “grasp toy,” “lift toy,” etc. Finally, each action is converted into specific motor commands for execution. One or more steps of the hierarchical approach may leverage an end-to-end methodology. That is, once a sufficient granularity of task is identified, the action identification model may perform in an end to end manner.

In some configurations, determining the objective action series may leverage additional information beyond the images and objective. This additional information can include a current environment state, a historical environment state, skill libraries, mechanical configurations, and other contextual data that informs how the robot 120 should perform actions in the working environment 110.

The current environment state represents the present condition of the working environment 110 and objects within it. This may include spatial relationships between objects, object positions, object orientations, and other real-time contextual information. For example, the current environment state may indicate that a toy bin is currently on the floor in the middle of the room rather than in its preferred location in the closet. The action identification model may use this information to determine that the objective action series should include actions to move the toy bin to the closet after collecting the toys.

The historical environment state represents previous conditions of the working environment 110 and objects within it. This may include information about where objects were located at previous times, how objects have moved over time, and patterns of activity in the environment. For example, the historical environment state may indicate that toys are typically scattered on the floor after a child plays in the room, and that the preferred state has the toys organized in the toy bin in the closet. The action identification model may use this historical information to understand the objective and generate appropriate actions.

The skill library stores predefined skills that the robot 120 can perform. Each skill represents a sequence of actions that accomplish a particular function. Skills can range from low-level actions such as “pick up object,” “place object,” or “navigate to location” to higher-level functions such as “clean the kitchen,” “set the table,” or “organize the bookshelf.” The skill library may include parameters for each skill, such as grip strength, motion paths, and timing information. The action identification model may access the skill library to determine which skills are available for accomplishing the objective and may incorporate those skills into the objective action series.

The mechanical configuration represents the physical capabilities and constraints of the robot 120. This may include information about the robot's actuators, joints, range of motion, payload capacity, and other mechanical properties. For example, the mechanical configuration may indicate that the robot 120 has a gripper with a maximum grip strength suitable for picking up lightweight toys but not heavy furniture. The action identification model may use this information to generate actions that are physically feasible for the robot 120 to execute.

The additional information described above may be explicitly provided to the action identification model when generating the objective action series, or may be implicitly present within the action identification model itself. The approach used depends on the configuration of the system environment 100 and the capabilities of the action identification model.

As an example of explicit provision, the action identification module 312 may access a current environment state from a state memory 340, retrieve relevant skills from a skill library 320, and query mechanical configuration parameters from the robot 120. The action identification module 312 then provides these pieces of information as separate inputs to the action identification model along with the images and objective. The action identification model processes all of these inputs together to generate the objective action series, explicitly considering each piece of information in its determination of what actions to perform.

As an example of implicit presence, the action identification model may have been trained on data that includes environment states, skills, and mechanical configurations such that this information is encoded within the model's parameters and weights. In this case, when the action identification module 312 provides only images and the objective to the action identification model, the model implicitly considers environment state information, available skills, and mechanical constraints based on its learned representations. The model generates the objective action series by processing the images and objective through its internal structure, where the additional information influences the output without being explicitly provided as separate inputs.

More generally, the action identification module 312 uses the visual information and additional information to generate a memory representing the working environment (e.g., the environment memory). The memory is a multimodal construct that captures information about the environment in various forms. This memory may include visual information such as appearance, pose, and information learned from images, semantic information such as object identity, logical relationships, and contextual meaning, and language information such as associations between objects, locations, and natural-language or voice task descriptions.

The memory can comprise specific data objects that explicitly represent discrete information about the working environment. For example, the memory may include specific data objects such as the exact position coordinates of a toy bin (e.g., x=2.5 meters (m), y=3.1m, z=0m), the dimensions of a doorway (e.g., width=0.9m, height=2.1m), the weight capacity of a shelf (e.g., 15 kilograms (kg)), and the current battery level of the robot (e.g., 78%). These specific data objects provide explicit, quantifiable information that the action identification model can directly access and use.

The memory can comprise representative data objects such as latent representations, embeddings, or encodings that capture information in a compressed or learned form. For example, the memory may include a latent vector encoding the spatial layout of a room, an embedding representing typical object arrangements in a bedroom, or a compressed visual representation capturing the appearance and relationships of objects without explicitly storing every pixel or measurement. These representative data objects allow the action identification model to work with learned patterns and relationships rather than explicit measurements.

The memory can comprise some combination of specific data objects and representative data objects. For example, the memory may store explicit position coordinates for key objects such as furniture (e.g., bed at x=1.2m, y=2.5m, closet at x=4.0m, y=1.0m) while simultaneously maintaining a latent representation of the overall room layout that captures spatial relationships, typical pathways, and contextual information about how objects relate to one another. This combined approach allows the action identification model to leverage both precise measurements and learned patterns.

Determining what actions to perform based on an objective can leverage the memory in various ways. For example, when given an objective to “organize the bookshelf,” the action identification model may access the memory (or relevant portions of the memory) to retrieve current book positions (specific data) and a learned representation of preferred book organization patterns (representative data). When given an objective to “navigate to the kitchen,” the action identification model may access spatial embeddings in the memory that encode the layout of the house and typical navigation paths. When given an objective to “pick up the fragile vase,” the action identification model may access stored grip strength parameters and material properties from the memory. When given an objective to “clean the room,” the action identification model may compare a current state representation in the memory with a preferred state representation to determine what actions are needed to achieve the objective.

The memory can be generated and updated using the relevant inputs from sensors, models, and other information sources within the control ecosystem 300. As the robot 120 operates in the working environment 110, the action identification module 312 continuously applies models to incoming sensor information to update the memory with new observations, changed object positions, modified spatial relationships, and other environmental changes. The memory may be updated in real-time as new sensor information is captured, or may be updated at scheduled intervals depending on the system configuration. Updates to the memory may modify existing representations, add new representations for newly observed objects or relationships, or remove representations for objects no longer present in the environment.

Certain parts of the memory may be indicated as “preferred” or “ideal” states that represent desired conditions of the working environment 110. For example, a preferred state representation may indicate that toys should be organized in a toy bin rather than scattered on the floor, or that a kitchen counter should be clear of objects. The preferred state representations may be generated based on user inputs such as images showing the desired arrangement, natural language descriptions of preferred conditions, or demonstrations of organizing actions. The action identification module 312 may compare current state representations in the memory with preferred state representations to determine what actions are needed to achieve the objective. The preferred state representations provide a reference point for the robot 120 to understand what conditions should be maintained or achieved in the working environment 110.

The memory representing the working environment 110 may be stored on the robot 120, on the network system 130, or distributed across both systems depending on the configuration of the system environment 100. The storage location influences how the memory is accessed, updated, and synchronized across the system.

When the memory is stored locally on the robot 120, the memory resides in the robot's memory 240 and can be accessed directly by the control system 210 without requiring network communication. Local storage enables the robot 120 to access memory representations with minimal latency, allowing rapid generation of actions based on current environment state. The robot 120 may periodically synchronize its locally stored memory with memory stored on the network system 130 to incorporate updates from other robots 120 operating in the same working environment 110 or to receive updated preferred state representations. For example, if multiple robots 120 are operating in a house, each robot may maintain local memory of the areas it has observed, and periodically upload that memory to the network system 130 where it is merged with memory from other robots to create a comprehensive representation of the entire house.

When the memory is stored on the network system 130, the memory resides in the environmental memory data store 330 and is accessed by robots 120 over the network 150. Cloud-based storage enables multiple robots 120 to access a shared memory representation of the working environment 110, facilitating coordination between robots by ensuring all robots operate with consistent environmental information. The network system 130 may aggregate memory updates from multiple robots 120 and maintain a unified memory representation that reflects observations from all robots. Robots 120 transmit sensor information to the network system 130, and the orchestration system 250 applies models to update the memory stored in the environmental memory data store 330. When generating the objective action series, robots 120 query the network system 130 to retrieve relevant portions of the memory.

In a distributed configuration, portions of the memory may be stored both locally on robots 120 and on the network system 130. Each robot 120 may maintain local memory of recently observed areas or frequently accessed information, while the network system 130 maintains a comprehensive memory of the entire working environment 110. The robot 120 may access its local memory for immediate action generation and query the network system 130 for memory of areas it has not recently observed. The robot 120 periodically backs up its local memory to the network system 130 to ensure that memory is preserved even if the robot experiences a failure or is powered down. Similarly, the robot 120 may download updated memory from the network system 130 to refresh its local memory with observations from other robots or updated preferred state representations provided by users.

In an embodiment, the memory representing the working environment 110 is structured as a semantic map. A semantic map is a data structure that represents the contextual relationships between objects and spaces in the working environment 110. The semantic map may be represented as a set of nodes and edges connecting those nodes, where each object or space is reflected as a node and information about that object or space is stored in the node. Edges between nodes within the semantic map represent different relationships and contextual information between objects represented by those nodes, such as spatial relationships, functional relationships, or hierarchical relationships.

The action identification module 312 generates and updates the semantic map by applying models to sensor information captured by the robot 120. For example, as the robot 120 navigates the working environment 110 and captures images, the action identification module 312 applies a model to those images to identify objects, determine their positions, and establish contextual relationships between them. The semantic map may include nodes representing rooms (e.g., “bedroom,” “kitchen”), furniture (e.g., “bed,” “closet,” “dresser”), and objects (e.g., “toys,” “pillows,” “comforter”). The edges connecting these nodes encode information such as containment relationships (e.g., the bedroom contains the bed), spatial proximity (e.g., the dresser is adjacent to the closet), and functional relationships (e.g., the pillows rest on the bed). The action identification module 312 may maintain both a current semantic map representing the present state of the working environment 110 and a preferred semantic map representing the desired state. When generating the objective action series, the action identification module 312 compares the current semantic map with the preferred semantic map to identify differences and determine what actions are needed to achieve the objective.

The memory representing the working environment 110 may be stored on the robot 120, on the network system 130, or distributed across both systems depending on the configuration of the system environment 100. The storage location influences how the memory is accessed, updated, and synchronized across the system.

When the memory is stored locally on the robot 120, the memory resides in the robot's memory 240 and can be accessed directly by the control system 210 without requiring network communication. Local storage enables the robot 120 to access memory representations with minimal latency, allowing rapid generation of actions based on current environment state. The robot 120 may periodically synchronize its locally stored memory with memory stored on the network system 130 to incorporate updates from other robots 120 operating in the same working environment 110 or to receive updated preferred state representations. For example, if multiple robots 120 are operating in a house, each robot may maintain local memory of the areas it has observed, and periodically upload that memory to the network system 130 where it is merged with memory from other robots to create a comprehensive representation of the entire house.

When the memory is stored on the network system 130, the memory resides in the environmental memory data store 330 and is accessed by robots 120 over the network 150. Cloud-based storage enables multiple robots 120 to access a shared memory representation of the working environment 110, facilitating coordination between robots by ensuring all robots operate with consistent environmental information. The network system 130 may aggregate memory updates from multiple robots 120 and maintain a unified memory representation that reflects observations from all robots. Robots 120 transmit sensor information to the network system 130, and the orchestration system 250 applies models to update the memory stored in the environmental memory data store 330. When generating the objective action series, robots 120 query the network system 130 to retrieve relevant portions of the memory.

In a distributed configuration, portions of the memory may be stored both locally on robots 120 and on the network system 130. Each robot 120 may maintain local memory of recently observed areas or frequently accessed information, while the network system 130 maintains a comprehensive memory of the entire working environment 110. The robot 120 may access its local memory for immediate action generation and query the network system 130 for memory of areas it has not recently observed. The robot 120 periodically backs up its local memory to the network system 130 to ensure that memory is preserved even if the robot experiences a failure or is powered down. Similarly, the robot 120 may download updated memory from the network system 130 to refresh its local memory with observations from other robots or updated preferred state representations provided by users.

In an embodiment, the memory representing the working environment 110 is structured as a semantic map. A semantic map is a data structure that represents the contextual relationships between objects and spaces in the working environment 110. The semantic map may be represented as a set of nodes and edges connecting those nodes, where each object or space is reflected as a node and information about that object or space is stored in the node. Edges between nodes within the semantic map represent different relationships and contextual information between objects represented by those nodes, such as spatial relationships, functional relationships, or hierarchical relationships.

The action identification module 312 generates and updates the semantic map by applying models to sensor information captured by the robot 120. For example, as the robot 120 navigates the working environment 110 and captures images, the action identification module 312 applies a model to those images to identify objects, determine their positions, and establish contextual relationships between them. The semantic map may include nodes representing rooms (e.g., “bedroom,” “kitchen”), furniture (e.g., “bed,” “closet,” “dresser”), and objects (e.g., “toys,” “pillows,” “comforter”). The edges connecting these nodes encode information such as containment relationships (e.g., the bedroom contains the bed), spatial proximity (e.g., the dresser is adjacent to the closet), and functional relationships (e.g., the pillows rest on the bed). The action identification module 312 may maintain both a current semantic map representing the present state of the working environment 110 and a preferred semantic map representing the desired state. When generating the objective action series, the action identification module 312 compares the current semantic map with the preferred semantic map to identify differences and determine what actions are needed to achieve the objective.

In some configurations, the memory (or semantic memory) may be used for context tuning a foundational model. The memory provides only the relevant information for the task as context, and the model acts on that information. For example, when the action identification module 312 generates the objective action series for a specific task, the module may retrieve only the portions of the environment memory that are relevant to that task and provide those portions as context to the action identification model. This selective provision of context allows the model to focus on pertinent information without processing the entire environment memory. The model may request additional information from the memory if it determines that additional context is needed to generate appropriate actions. For instance, if the model is generating actions for organizing a bookshelf and determines that information about preferred book arrangements is needed, the model may request that specific information from the memory. The memory system responds to such requests by retrieving and providing the requested information as additional context.

Additionally, the memory system supports selective operations on semantically or contextually relevant portions rather than requiring processing of the entire memory representation. When updating, storing, accessing, or generating the memory, the action identification module 312 (or orchestration module 314) may identify and operate on only those portions of the memory that are relevant to the current task or objective. For example, when the robot 120 is performing an action to organize books on a bookshelf in the living room, the action identification module 312 may retrieve and update only the portion of the environment memory corresponding to the bookshelf and its immediate surroundings, rather than processing memory representations for the entire house. Similarly, when generating motor commands for picking up a toy from the bedroom floor, the action execution model may access only the memory portion encoding spatial relationships and object positions within the bedroom, without requiring access to memory representations of other rooms such as the kitchen or bathroom. This selective processing reduces computational overhead and enables faster action generation by focusing processing resources on contextually relevant information.

Overall, the action identification module 312 is configured for receiving objectives and generating the objective action series to accomplish them in the working environment 110. The module applies an action identification model to images and sensor information, generating actions through an end-to-end approach, a hierarchical approach, or a combination of both depending on the complexity of the objective and the capabilities of the robot 120. The module leverages additional information including current environment state, historical environment state, skill libraries, and mechanical configurations, which may be provided as explicit inputs or implicitly encoded within the model's learned representations. The module operates on memory representing the working environment as a multimodal construct comprising visual, semantic, and language information. This memory may comprise specific data objects that explicitly represent discrete information, representative data objects such as latent representations and embeddings that capture information in compressed learned forms, or a combination of both. Through these mechanisms, the action identification module 312 enables robots to generate appropriate actions for accomplishing objectives in dynamic working environments.

### Task Coordination

The orchestration engine 310 includes a task coordination module 314. The task coordination module 314 orchestrates identified actions to achieve the objective. Orchestration, in this context, means sequencing and assigning identified actions to robots 120 such that those actions are performed in an efficient manner. In other words, the task coordination module 314 plans how the robot(s) 120 executes actions to achieve the user-defined objective and instructs the robot 120 to execute those actions accordingly.

To demonstrate, at a high level, the task coordination module 314 receives actions identified to accomplish an objective. The task coordination module 314 inputs the identified actions and data from various sources such as sensor inputs, memory representations, robot states, robot skills, etc. that are relevant in orchestrating the actions. The task coordination module 314 uses those inputs to coordinate actions between robots 120 in the working environment 110. For example, the task coordination module 314 may determine, e.g., which robots 120 in the working environment 110 are suited to perform which actions, the order in which actions should be performed, any relevant sub-actions related to each action, etc.

To illustrate, at a more granular level, a robust contextual example of action orchestration is provided. In this example, the working environment 110 is a house. Within that house is a bedroom, and in that bedroom is a bed, a closet, a toy-bin, a mirror, and a dresser. The room is messy, for example, the bed is unmade, the closet door is open, toys are strewn across the floor, the mirror is smudged, and the dresser has open drawers. Two agentic robots 120A, 120B are in the house. One robot 120A is in the bedroom and one robot 120B is in the bathroom. Each of the robots 120 are disparately configured. For example, the robot 120A in the bedroom may include mechanical systems 230 sufficient for basic actions such as picking up objects, translating objects, etc., while the robot 120B in the bathroom may include mechanical systems 230 configured for more dexterous actions such as cleaning, folding, and washing.

A user operating a user device 140 inputs a user-defined objective. In this case, the user-defined objective is a recording of a natural language request to “Clean the child's bedroom.” The orchestration engine 310 inputs and processes the audio request for context and sentiment to identify the objective for the robot(s) 120 to clean the bedroom. As noted above, the orchestration engine 310 may utilize a LMM to determine the objective based on the recorded request.

Given the user-defined objective, the action identification module 312 generates the objective action series to accomplish the objective. To do so, as described above, the action identification module 312 accesses relevant data from the first robot 120 including memory representing the state of bedroom. The action identification module 312 inputs the user-defined objective and the relevant data into the action identification model, and the action identification model generates actions in the bedroom that accomplish the objective of cleaning the bedroom. In this case, the actions include putting toys in the toy-bin, making the bed, cleaning the mirror, and closing the drawers. The action identification model may generate the actions using an end-to-end approach, a hierarchical approach, or some combination thereof.

With the actions relevant for accomplishing the objective identified, the task coordination module 314 orchestrates the actions between the robots 120A, 120B. To do so, the task coordination module 314 may apply a task orchestration model (“orchestration model”) to the identified actions. The orchestration model may be a visual language model or some other model trained to orchestrate actions to accomplish an objective based on the semantic and/or pre-trained associations between actions, the mechanical systems 230 required to complete those actions, and the skills those mechanical systems 230 need to perform to accomplish the actions. In an embodiment, the orchestration model may be the same model as the action identification model but could also be a different model.

Again, the task coordination module 314 applies the orchestration model to the identified actions, and the orchestration model generates an action plan as a result. The action plan is a sequential set of actions that robots 120A, 120B in the working environment 110 perform to accomplish the objective. In doing so, the orchestration model may recognize and access information associated with and/or relevant to those actions and objective from within the control ecosystem 300. The orchestration model may identify relevant information based on pre-trained associations and/or contextual semantic associations derived from the identified actions and/or objective. For instance, the orchestration model may access a state of the bedroom, memory of the bedroom, a preferred memory of the bedroom, skill libraries for each robot 120A, 120B, a state for each robot 120A, 120B, memory of the house, positional information for each robot 120, etc. given the user-defined objective.

The task coordination module 314 generates an action plan based on the accessed information and the identified actions. The generated action plan takes into account the capabilities of each robot 120 such that the robots 120, acting together, accomplish the objective efficiently.

To illustrate, in this example, the orchestration model may identify that the first robot 120 is suited for simple object manipulation actions such as placing toys in the toy bin, closing the drawers, and making the bed based on the skill library of that robot 120 and the state of the bedroom. Additionally, the orchestration model may determine that the first robot 120 is not capable of accomplishing the more dexterous actions of cleaning the mirror and is not capable of accomplishing a larger action like making the bed by itself. In turn, the orchestration model determines to utilize the second robot 120 to accomplish cleaning the mirror and making the bed. Thus, the task coordination module 314 generates an action plan that includes the first robot 120 picking up the toys, closing the closet, closing the drawers, the second robot 120 cleaning the mirror, and both robots 120 making the bed.

The orchestration model may also create an action plan that optimizes the use of both robots 120 based on the accessed information (e.g., position of the robots 120, skill library, etc.). For example, the action plan may schedule the first robot 120 to start its actions at an earlier time than the second robot 120. It may do so because the orchestration model determines (based on the state of the bedroom, state of the robot 120, and the skills of that robot 120) that the first robot 120A will take a significant amount of time to accomplish its individual actions (e.g., picking up the toys and closing the drawers). To that end, the action plan may schedule the second robot 120B to begin the action of cleaning the mirror at a later time such that both the first robot 120A and second robot 120B finish their actions at approximately the same time. In this way, the robots 120A, 120B can efficiently move to accomplish the joint action of making the bed without much down time between their individual actions.

Of course, this is just an example, and there are many possibilities for orchestrating actions between robots 120 in a working environment 110. Importantly, generating the action plan considers various relevant information associated with accomplishing an objective. Thus, in some cases, relevant information for a first objective and corresponding set of actions is not the same as relevant information for a second objective and corresponding set of actions. Moreover, one or more additional algorithms or models may be applied to an action plan to optimize actions within that plan. As above, the algorithms and/or models may access information relevant to creating an efficient action plan within the working environment 110.

The task coordination module 314 may employ different coordination strategies depending on various factors in the working environment 110 and the characteristics of the objective. The selection of a coordination strategy influences how efficiently the one or more robots 120 accomplish the objective and how safely they operate in the working environment 110.

One factor influencing coordination strategy may be the temporal requirements of the objective. Some objectives may require immediate completion, while others may be performed over an extended time period. For objectives requiring immediate completion, the task coordination module 314 may generate an action plan that assigns actions to multiple robots 120 operating simultaneously to minimize total completion time. For objectives that can be performed over an extended period, the task coordination module 314 may generate an action plan that sequences actions across robots 120 to optimize energy consumption or minimize wear on mechanical systems 230. For example, when given an objective to “clean the house,” the task coordination module 314 may determine whether the objective should be completed immediately or can be performed gradually throughout the day, and may adjust the action plan accordingly.

One factor influencing coordination strategy may be the capabilities and availability of robots 120 in the working environment 110. Different robots 120 may have different mechanical systems 230, different skill libraries 320, and different states at any given time. The task coordination module 314 accesses information about each robot's capabilities and current state to determine which robots 120 are best suited for which actions. For example, a robot 120 with advanced manipulation capabilities may be assigned actions requiring dexterous object handling, while a robot 120 with enhanced mobility may be assigned actions requiring navigation across large distances. Additionally, if a robot 120 is currently performing another objective or has low battery charge, the task coordination module 314 may assign actions to other available robots 120.

One factor influencing coordination strategy may be the skill libraries available to each robot 120 in the working environment 110. Each robot 120 may have a different skill library 320 containing skills that the robot can perform, and the task coordination module 314 accesses these skill libraries to determine which robots are capable of performing which elements of the objective. For example, if a first robot 120A has skills for delicate object manipulation in its skill library while a second robot 120B has skills for heavy lifting, the task coordination module 314 may assign actions requiring fine motor control to the first robot 120A and actions requiring strength to the second robot 120B. As a second example, if a first robot 120A has higher-level skills such as “clean the kitchen” or “organize the living room” in its skill library while a second robot 120B has more specialized skills such as “do laundry” or “clean the bathroom,” the task coordination module 314 may assign objectives to the first robot 120A and the second robot 120B based on their capabilities. Additionally, the task coordination module 314 may identify situations where multiple robots 120 must combine their skills to accomplish an element that no single robot can perform alone. For instance, if an objective requires both precise positioning and sustained force application, the task coordination module 314 may generate an execution plan that coordinates two robots 120 to work together, with one robot providing positioning control while the other applies force.

One factor influencing coordination strategy may be the presence and location of people in the working environment 110. The task coordination module 314 may access sensor information indicating where people are located in the working environment 110 and may adjust the action plan to minimize disruption to those people or to avoid safety concerns. For example, if people are present in a room where actions need to be performed, the task coordination module 314 may delay those actions until the people leave the room or may assign those actions to robots 120 that can operate safely around people. Similarly, if an objective involves actions in multiple rooms and people are present in some of those rooms, the task coordination module 314 may sequence actions to first complete work in unoccupied rooms before moving to occupied rooms.

One factor influencing coordination strategy may be room usage patterns and environmental constraints. The task coordination module 314 may access information about typical usage patterns for different areas of the working environment 110 and may schedule actions during times when those areas are typically unoccupied or less frequently used. For example, the task coordination module 314 may schedule actions in a kitchen during times when the kitchen is not typically used for meal preparation. Additionally, environmental constraints such as doorway widths, furniture placement, and floor surfaces may influence which robots 120 are assigned to which actions and how those actions are sequenced. For example, if a doorway is too narrow for a particular robot 120 to pass through, the task coordination module 314 will assign actions in the room beyond that doorway to a different robot 120 that can fit through the doorway.

One factor influencing coordination strategy may be the type of room and the people who typically use that room. The task coordination module 314 may access information about room types and typical occupants to adjust the action plan accordingly. For example, the task coordination module 314 may avoid scheduling actions in children's bathrooms or bedrooms during typical sleep hours to minimize disruption. Similarly, if a room is designated as a private space for a particular user, the task coordination module 314 may restrict robot access to that room or may only schedule actions when that user has explicitly granted permission. The task coordination module 314 may also consider the sensitivity of different room types when determining which robots 120 to assign to which actions. For example, actions in bathrooms or bedrooms may be assigned to robots 120 with enhanced privacy features or may be scheduled only when those rooms are unoccupied.

Overall, the complexity and interdependencies of actions also influence coordination strategy. Some actions may need to be performed in a specific sequence because later actions depend on the completion of earlier actions. The task coordination module 314 identifies these dependencies and generates an action plan that respects the required sequencing. For example, if an objective involves both clearing a table and washing dishes, the action of clearing the table must be completed before the action of washing dishes can begin. The task coordination module 314 may assign these actions to different robots 120 operating in sequence or may assign both actions to a single robot 120 if that robot has the necessary capabilities. Additionally, some actions may be performed in parallel without dependencies, and the task coordination module 314 may assign these actions to multiple robots 120 operating simultaneously to reduce total completion time.

Notably, in situations where action generation and task coordination are distributed between the robot and the network system, relevant information can be passed between the two systems in a variety of ways.

Information can be passed directly between the robot 120 and the network system 130 in its original form. For example, the robot may transmit raw sensor measurements such as images, LiDAR data, or force measurements to the network system over the network 150. The network system 130 receives the sensor measurements and applies models to that information to generate the objective action series or coordinate actions between multiple robots. Similarly, the network system 130 may transmit natural language objectives or action descriptions directly to the robot 120, and the robot 120 receives and processes those natural language inputs to generate motor commands.

Information can be passed between the robot 120 and the network system 130 in reduced formats that compress the information while preserving essential content. For example, the robot 120 may apply a model to sensor information to generate a latent representation or embedding that captures spatial layouts, object arrangements, and contextual relationships in a compressed form. The robot 120 transmits the latent representation to the network system rather than transmitting raw images or sensor measurements. The network system 130 receives the latent representation and applies models to that compressed information to generate the objective action series. Similarly, the network system may encode action plans or objectives into compact representations such as embeddings or compressed vectors before transmitting them to the robot 120. The robot 120 receives the compressed representation and decodes it to generate motor commands. Passing information in reduced formats decreases bandwidth requirements while maintaining sufficient information for coordination between the robot and network system.

Information exchange between the robot 120 and the network system 130 can occur through a request-based mechanism where either system requests additional information as needed. For example, when the network system 130 generates an action plan for multiple robots, the orchestration system 250 may determine that additional sensor measurements from a specific robot 120 are needed to coordinate actions effectively. The network system 130 transmits a request to that robot 120 specifying what sensor information is needed, and the robot captures and transmits the requested sensor information in response. Similarly, when a robot 120 receives assigned actions from the network system 130, the control system 210 may determine that clarification about a particular action is needed. The robot 120 transmits a request to the network system for additional information about the action, and the network system provides the requested clarification.

The models themselves may determine what additional information is required during processing and trigger requests for that information. For example, when the orchestration system 250 applies an orchestration model to generate an action plan, the model may identify that historical state information about the working environment is needed to determine appropriate action sequencing. The orchestration model triggers a request to retrieve historical state information from the state memory 340, and the orchestration system 250 receives the requested information and incorporates it into the action plan generation. Similarly, when the control system 210 applies an action execution model to generate motor commands, the model may identify that updated environment memory is needed to account for recent changes in object positions. The action execution model triggers a request to retrieve updated environment memory from the environmental memory data store 330 or from the network system 130, and the control system 210 receives the updated memory and uses it to generate motor commands.

### Task Execution

The orchestration engine 310 includes a task execution module 316. The action execution module 316 generates machine commands for mechanical systems 230 of a robot 120 to perform actions that accomplish an objective. Machine commands, in this context, means one or more signals configured to cause a mechanical system 230 to actuate in order to perform an action. The action execution module 316 may generate machine commands using an end-to-end approach, a hierarchical approach, or some combination thereof. At a high level, the action execution module 316 is responsible for causing the robot 120 to execute actions to accomplish an objective.

Providing more detail, in an end-to-end approach, the action execution module 316 directly generates machine commands from sensor information and an objective without explicitly decomposing the objective into intermediate tasks or actions. The action execution module 316 applies an action execution model to sensor information (e.g., images of the working environment 110) and the objective, and the action execution model directly outputs machine commands that cause the robot 120 to accomplish the objective. The action execution model may be a large multimodal model, a visual language model, or some other model trained to generate machine commands based on sensor information and objectives. The action execution model processes the sensor information and objective through learned representations to generate the physical motor commands required for the robot 120 to achieve the objective.

To illustrate the end-to-end approach, consider an example where the working environment 110 is a bedroom with toys scattered across the floor and a toy bin. The robot 120 receives an objective to “pick up the toys.” The action execution module 316 receives images of the bedroom from sensors 220 of the robot 120 and the objective. The action execution module 316 applies the action execution model to the images and objective, and the action execution model directly generates machine commands for the mechanical systems 230. The machine commands may include, e.g., signals to actuate motors controlling the robot's wheels to navigate to a toy location, signals to actuate arm joints to position the gripper near the toy, signals to close the gripper around the toy, signals to lift the arm, signals to navigate to the toy bin, and signals to open the gripper to release the toy. The action execution model generates these machine commands in a continuous manner as the robot 120 operates in the working environment 110, processing updated sensor information to adapt the commands based on the current state of the environment.

The end-to-end approach may leverage additional information to generate machine commands. For instance, the action execution model may access memory representations of the working environment 110, skill libraries, mechanical configurations of the robot 120, and other contextual data. This additional information may be explicitly provided as inputs to the action execution model or may be implicitly encoded within the model's parameters based on training. The action execution model uses this information to generate machine commands that are appropriate for the specific working environment 110 and robot 120 configuration.

To illustrate a hierarchical approach, the action execution module 316 receives identified tasks or actions and generates machine commands by decomposing those tasks or actions into more granular elements. The action execution module 316 applies an action execution model to the identified tasks or actions, and the action execution model generates action sets and corresponding machine commands to implement those action sets. An action set represents a series of mechanical movements the robot 120 performs to accomplish a task or action. The action execution model may be a large multimodal model or some other model trained to generate action sets and machine instructions based on semantic and pre-trained associations between tasks, action sets, and machine commands for the mechanical systems 230.

To illustrate the hierarchical approach, consider the same bedroom example where the control ecosystem 300 has previously employed the action identification module 312 to identify actions pertinent to the user-defined objective of “cleaning up the toys,” and employed the task coordination module 314 to orchestrate those actions. The action execution module 316 receives an identified action such as “pick up a toy.” The action execution module 316 applies the action execution model to this identified action along with relevant information from the control ecosystem 300 such as sensor information, memory representations, robot states, and skill libraries. The action execution model generates an action set for “pick up a toy” that may include sub-actions such as “navigate to toy location,” “position arm near toy,” “grasp toy,” and “lift toy.” Each of these sub-actions may be further decomposed into more granular actions. For example, “grasp toy” may include actions such as “articulate arm down,” “open gripper,” “center gripper on object,” “close gripper,” and “articulate arm up.” The action execution model then generates machine commands for each of these granular actions. The machine commands may include signals that cause an actuator controlling the arm of the robot 120 to move downwards in space, signals to open the gripper, signals to close the gripper around the toy, etc.

The hierarchical approach allows the action execution module 316 to leverage structured decomposition of tasks and actions while generating machine commands. The action execution model may recognize and access information associated with the identified tasks or actions from within the control ecosystem 300. It may identify relevant information based on pre-trained associations and contextual semantic associations derived from the identified tasks and objective. For instance, the action execution model may access a current and previous state of the robot 120, memory representations of the bedroom, proximity and positional information of the robot 120, skill libraries for the robot 120, etc., given the task at hand. The action execution model uses this information to generate action sets and machine commands that are appropriate for accomplishing the task in the specific working environment 110.

The action execution module 316 may also generate machine commands using a combination of hierarchical and end-to-end approaches. In this combined approach, the action execution module 316 may use hierarchical decomposition for high-level objective planning while employing end-to-end generation for executing specific actions. For example, when given a high-level objective such as “organize the living room,” the action execution module 316 may first apply an action execution model that hierarchically decomposes the objective into tasks such as “arrange books on shelf,” “organize toys in bin,” and “straighten cushions on couch.” For each of these identified tasks, the action execution module 316 may then switch to an end-to-end approach where the action execution model directly generates motor commands from sensor information without further explicit decomposition. To illustrate, for the task “arrange books on shelf,” the action execution model may receive images of the bookshelf and directly output motor commands that cause the robot 120 to navigate to a book, grasp it, move it to the appropriate shelf location, and place it, all without explicitly defining intermediate actions like “open gripper” or “articulate arm down.” This combined approach allows the system to leverage the benefits of hierarchical planning for complex objectives while maintaining the efficiency and adaptability of end-to-end execution for individual tasks.

Of course, these are examples, and there are many possibilities for executing actions within the working environment 110. The action execution module 316 may use an end-to-end approach, a hierarchical approach, or some combination thereof depending on the complexity of the objective, the capabilities of the robot 120, and the configuration of the system environment 100. Importantly, generating machine commands considers various relevant information associated with accomplishing an objective. Thus, in some cases, relevant information for a first objective is not the same as relevant information for a second objective.

The action execution module 316 may coordinate with the task coordination module 314 to execute actions across multiple robots 120 in the working environment 110. When the task coordination module 314 generates an action plan that assigns actions to multiple robots 120, the action execution module 316 receives the assigned actions for each robot 120 and generates the appropriate machine commands for that robot's mechanical systems 230. The action execution module 316 may coordinate timing of action execution across robots 120 to ensure that actions are performed in the sequence specified by the action plan. For example, if the action plan specifies that a first robot 120A should complete an action before a second robot 120B begins its action, the action execution module 316 may monitor the execution status of the first robot 120A and signal the second robot 120B to begin its action once the first robot 120A has completed its assigned action. The action execution module 316 may also coordinate spatial positioning of robots 120 to prevent collisions and ensure safe operation when multiple robots 120 are operating in proximity to one another.

To illustrate coordination with an end-to-end approach, consider an example where two robots 120A, 120B are tasked with doing laundry in the working environment 110. The task coordination module 314 generates an action plan that assigns coordinated actions to both robots 120. The action execution module 316 receives sensor information (e.g., images of the laundry, hamper, and washing machine) and the objective to “do the laundry” for each robot 120. For each robot 120, the action execution module 316 applies an action execution model that directly generates machine commands from the sensor information and objective. The action execution model for the first robot 120A generates machine commands to navigate to the bedroom, identify clothing items on the floor, grasp each item, sort items by type and color, and transport sorted items to the laundry room. Simultaneously, the action execution model for the second robot 120B generates machine commands to prepare the washing machine, receive sorted laundry from the first robot 120A, load items into the washing machine, add detergent, and start the wash cycle. The action execution module 316 coordinates the timing and handoff between the two robots 120 by continuously processing updated sensor information that captures the position and status of both robots 120, the laundry items, and the washing machine. The action execution models for both robots 120 adapt their generated machine commands in real-time based on the sensor information to maintain coordinated operation and ensure efficient completion of the laundry objective.

To illustrate coordination with a hierarchical approach, consider the same example where two robots 120A, 120B are tasked with doing laundry. The task coordination module 314 generates an action plan that decomposes the objective into coordinated tasks such as “get laundry from bedroom,” “sort laundry by type,” “take laundry to washer,” “load washer,” and “start wash cycle.” The action execution module 316 receives these identified tasks for each robot 120. For the first robot 120A, the action execution module 316 applies an action execution model to the task “get laundry from bedroom” and generates machine commands to accomplish this task. Similarly, for the second robot 120B, the action execution module 316 generates machine commands for “load washer.” The action execution module 316 coordinates execution by ensuring that the first robot 120A completes the task of collecting and sorting laundry before the second robot 120B proceeds to the task of loading the washer. The machine commands for both robots 120 are coordinated such that they operate in sequence based on task dependencies, with sensor feedback ensuring smooth handoffs between tasks. This coordination continues through the sorting, transporting, and loading tasks until the objective is accomplished.

In some configurations, the action execution module 316 may employ a low-frequency control system and a high-frequency control system to generate and monitor machine commands. The low-frequency control system continuously generates and outputs machine commands that the robot 120 executes to accomplish an objective. The low-frequency control system may generate these machine commands using an end-to-end approach, a hierarchical approach, or some combination thereof. For example, the low-frequency control system may apply an action execution model to sensor information and an objective to directly generate motor commands, or may decompose tasks into action sets before generating motor commands. The generated machine commands are transmitted to the high-frequency control system for execution.

The high-frequency control system receives the machine commands from the low-frequency control system and executes those commands on the mechanical systems 230 of the robot 120. The high-frequency control system monitors the overall whole-body state of the robot 120 during execution to ensure that the robot 120 operates safely and within defined operational parameters. The whole-body state includes information such as joint positions, joint velocities, applied forces, spatial positioning relative to objects in the working environment 110, and other state information relevant to safe operation. The high-frequency control system continuously evaluates whether executing a machine command would violate policies governing the robot 120, and supersedes or modifies commands that would cause policy violations.

The policies governing the robot 120 may include proximity thresholds that define minimum safe distances between the robot 120 and objects in the working environment 110, force limits that define maximum forces the robot 120 may apply when interacting with objects, velocity limits that define maximum speeds for robot movements, and collision avoidance policies that prevent the robot 120 from colliding with objects or people in the environment. For example, if the low-frequency control system generates a machine command that would cause the robot 120 to move its arm within a proximity threshold of a fragile object, the high-frequency control system may supersede that command and generate an alternative command that maintains safe distance. Similarly, if a machine command would cause the robot 120 to apply excessive force when grasping an object, the high-frequency control system may modify the command to reduce the applied force to within acceptable limits.

The high-frequency control system operates at a higher update rate than the low-frequency control system. For example, the low-frequency control system may generate machine commands at a rate of 1-10 Hz, while the high-frequency control system may execute and monitor those commands at a rate of 100-1000 Hz or higher. This difference in update rates allows the high-frequency control system to react quickly to changing conditions in the working environment 110 and ensure safe operation even when the low-frequency control system generates commands based on slightly outdated sensor information. The high-frequency control system continues to execute the most recent machine command from the low-frequency control system until a new command is received, making adjustments as needed to maintain policy compliance.

In some configurations, the orchestration engine 310 is configured to assist action execution when the low-frequency control system or high-frequency control system are unable to complete an action, enter a loop, or make a mistake. For instance, the high-frequency control system may output a series of errors indicating that machine commands consistently violate policies, or the low-frequency control system may output the same action repeatedly without making progress toward the objective. The orchestration engine 310 may detect these error conditions by monitoring execution status information from the robot 120. Responsive to detecting an error condition, the orchestration engine 310 may modify the objective action series, generate alternative actions, adjust parameters in the action execution model, or provide additional contextual information to the low-frequency control system to alleviate the issues. For example, if the robot 120 is unable to grasp an object due to repeated policy violations, the orchestration engine 310 may generate an alternative action that approaches the object from a different angle or uses a different grasping strategy.

### Skills and Skill Library

The control ecosystem 300 includes a skill library 320. The skill library 320 is a database that stores a comprehensive set of skills that each robot 120 can perform. A skill represents a capability of the robot 120 to execute actions based on images and task inputs, where the robot's neural network directly outputs motor commands to accomplish those actions. Skills in the skill library 320 can range from low-level capabilities to high-level functionalities, depending on the level of abstraction at which the robot 120 operates.

Skills may represent generic capabilities that the robot 120 has learned through large-scale training, such as basic manipulation skills like pick and place, or opening and closing objects. For example, a skill such as “pick up object” represents the robot's ability to take in an image showing an object and a task input specifying which object to pick up, and directly generate motor commands that cause the robot 120 to grasp and lift that object. The skill library also fills in gaps between generic training and user-specific requirements. For instance, skills may include how to operate a specific appliance in a user's home, how to grasp a specific object that is outside the robot's prior training distribution, or any other capability beyond the robot's prior knowledge. Skills may also correspond to specific parameters such as the exact force and jerk required to open a particular door, which the robot 120 learned from prior experience and recorded for future use.

Skills can also represent higher-level task capabilities. For example, if a higher-level task input to the robot 120 is “Move these toys from the carpet to toy bin and white shelf,” the robot 120 may generate sub-actions like “Pick X object from floor in front of robot” or “Flip X object to move it to right orientation before picking up,” along with the motor commands needed to execute those sub-actions. Another example of a higher-level skill is operating a specific laundry machine in a user's home. Each skill, whether low-level or high-level, enables the robot 120 to accomplish objectives by generating appropriate motor commands based on visual inputs and task descriptions.

Robots 120 may be initially provisioned with a base skill library 320 that includes generic skills learned through large-scale training across diverse environments and tasks. The base skill library includes foundational capabilities such as basic manipulation skills (e.g., pick and place, open and close), navigation skills, and object interaction skills that are broadly applicable across different working environments 110. It may also include some larger scale skills such as “clean a room” or “take in the groceries.” These skills may be adapted to a specific working environment 110 over time.

To expand, when a robot 120 is deployed in a specific working environment 110, the skill library 320 is updated and adapted to include environment-specific skills tailored to that particular house or workspace. For example, the base skill library may include a generic skill for “open door” that represents the robot's general capability to open doors. As the robot 120 operates in the specific working environment 110, it learns the particular characteristics of individual doors in that environment, such as the force required to open the master bedroom door, the handle type and orientation of the kitchen door, or the friction characteristics of the closet door. The robot 120 stores these environment-specific parameters and creates specialized skills such as “open master bedroom door” that incorporate the learned parameters. This adaptation process allows the robot 120 to perform tasks more efficiently and reliably in its specific working environment 110 while maintaining the foundational capabilities from the base skill library.

Additionally, users can train new skills or refine existing skills in the skill library 320 for the robot 120 and may do so through several methods.

Robust description of training and refining skills is provided below. However, several brief examples are also provided here to provide context. In a first example, users can train skills through physical demonstration by guiding the robot 120 through the desired actions. In an example method, a user may physically guide the robot's arms and gripper through the process of arranging items on a shelf in a preferred manner, and the robot 120 records the demonstrated movements, forces, and sequences to create a new skill. In an example method, users can train skills through natural language input by providing verbal or written descriptions of desired tasks. For example, a user may provide a natural language instruction such as “when folding towels, fold them in thirds lengthwise and then in half” and the robot 120 processes this instruction to generate or modify a skill for folding towels according to the specified method. In an example, users can train skills through post-hoc corrections to previous skill execution. For example, if the robot 120 performs a task in a manner that does not meet the user's preferences, the user can provide corrective feedback indicating how the task should have been performed differently, and the robot 120 updates the corresponding skill based on the feedback. These training methods can be combined in various manners and generally allow users to customize the robot's behavior to match their specific preferences and requirements in the working environment 110.

### Datastores

The control ecosystem 300 includes a environmental memory data store 330. The environmental memory data store 330 stores memory representations of the working environment 110. As described above, memory is a multimodal construct that captures information about the environment in various forms including visual information such as appearance, pose, and information learned from images, semantic information such as object identity, logical relationships, and contextual meaning, and language information such as associations between objects, locations, and natural-language or voice task descriptions. The memory can comprise specific data objects that explicitly represent discrete information about the working environment 110, representative data objects such as latent representations, embeddings, or encodings that capture information in a compressed or learned form, or some combination of specific data objects and representative data objects.

In some configurations, the memory representing the working environment 110 is structured as a semantic map. A semantic map is a data structure that represents the contextual relationships between objects and spaces in the working environment 110. The semantic map may be represented as a set of nodes and edges connecting those nodes, where each object or space is reflected as a node and information about that object or space is stored in the node. Edges between nodes within the semantic map represent different relationships and contextual information between objects represented by those nodes, such as spatial relationships, functional relationships, or hierarchical relationships.

To provide a concrete illustration, consider the working environment 110 of a house. The semantic map includes a node representing “house,” “bedroom,” “kitchen,” etc. The edges connecting those nodes may represent contextual relationships between those nodes such as their relative position. For instance, edges connecting bedroom to house and bedroom to kitchen may indicate that the bedroom and the kitchen are inside the house. Additionally, the node “bedroom” may be connected to nodes such as “bed,” “closet,” “dresser,” etc. The edges connecting these nodes may indicate that the latter nodes are within the bedroom, and their spatial relationship to each other. Still further, the node “bed” may be connected to nodes “sheets,” “pillows,” and “comforter.” The edges between these nodes may indicate that the latter are on the bed, and may indicate that the sheets are on bottom, the comforter are on top of the sheets, and the pillows are on top of the comforter.

The action identification module 312 generates and updates the semantic map by applying models to sensor information captured by the robot 120. For example, as the robot 120 navigates the working environment 110 and captures images, the action identification module 312 applies a model to those images to identify objects, determine their positions, and establish contextual relationships between them. The action identification module 312 may maintain both a current semantic map representing the present state of the working environment 110 and a preferred semantic map representing the desired state. When generating the objective action series, the action identification module 312 compares the current semantic map with the preferred semantic map to identify differences and determine what actions are needed to achieve the objective.

In configurations where memory is not structured as a semantic map, the memory may be stored as latent representations, embeddings, or other implicit forms that capture visual, semantic, and language information without explicit node-edge structures. These latent representations encode information about the working environment 110 in a compressed, learned form that the action identification module 312 can process to generate the objective action series. The latent representations may be generated by neural networks that process sensor information and encode patterns, relationships, and contextual information into high-dimensional vector spaces.

To provide a concrete illustration, consider the working environment 110 of a house where the robot 120 has been operating for several weeks. As the robot 120 navigates through different rooms and captures images, the action identification module 312 applies a model to those images to generate latent representations of the environment. The model may generate a latent vector encoding the spatial layout of the kitchen that captures information such as the typical positions of appliances, the arrangement of cabinets and counters, and common pathways through the space. This latent vector does not explicitly store coordinates or measurements, but instead encodes learned patterns about the kitchen's structure in a compressed form. Similarly, the model may generate embeddings that represent typical object arrangements in the bedroom, such as where toys are usually found, where clothing is typically placed, and how furniture is positioned relative to one another.

The latent representations may also capture temporal patterns and behavioral information about the working environment 110. For example, the memory may include embeddings that encode typical usage patterns for different rooms, such as when the kitchen is most frequently used, which objects are moved most often, or how the state of a room typically changes throughout the day. These temporal embeddings allow the action identification module 312 to anticipate environmental conditions and generate appropriate actions based on time-dependent patterns. Additionally, the memory may include language embeddings that associate natural language descriptions with visual features, allowing the robot 120 to understand objectives expressed in natural language and map them to appropriate actions in the environment.

When generating the objective action series, the action identification module 312 accesses these latent representations from the environmental memory data store 330 and uses them to inform action generation. For example, when given an objective to “organize the living room,” the action identification module 312 may retrieve latent vectors encoding the current state of the living room and embeddings representing preferred organization patterns. The action identification model processes these latent representations along with current sensor information to generate actions that transform the current state toward the preferred state. The latent representations provide contextual information that guides action generation without requiring explicit symbolic reasoning about object positions or relationships. This approach allows the robot 120 to leverage learned patterns and relationships captured during prior operation in the working environment 110.

Whatever the representation, the environmental memory data store 330 stores the memory such that it can be accessed by modules within the control ecosystem 300 to generate the objective action series and accomplish objectives in the working environment 110.

The control ecosystem 300 includes a state memory 340. The state memory 340 stores current and previous robot states. Current robot states can include a state or a measurement representing a state of the robot 120 and/or mechanical systems 230 of the robot 120. As an example, the current state may include position information for the robot 120 within environment and the current position of, e.g., a robot 120 arm relative to the robot 120 chassis. Previous robot states can include state information from a previous timeframe. Previous state information can be useful in identifying tasks, orchestrating tasks, and executing tasks as the provide a history of the robot 120 for analysis. For example, reviewing the previous state of the robot 120 can inform, e.g., whether an element of the robot 120 is broken, etc. The state memory 340 also stores current and previous working environment 110 states. As noted above, the working environment 110 states may be represented as a semantic map. However, the state memory can also store additional or different representation of the working environment 110 including, e.g., data structures representing objects in the working environment 110, the robot 120, etc.

### Training

As described above, the control ecosystem 300 employs various models to identify, coordinate and execute tasks to accomplish a user-defined objective in the working environment 110. Developing these models is a complex, time consuming, and computationally expensive task due to the varied nature if objectives, tasks, actions, working environments, etc. Disclosed herein are one or more methods for employing a training module 350 to train models within the control ecosystem 300 to accomplish objectives by orchestrating and performing tasks. As disclosed herein, “training” can indicate several different actions with the system environment. In an example, training can indicate generating the models from first principles to a usable, executable model for the agentic systems described herein. In example, training can include updating, or increasing the capabilities of, current models for the agentic systems described herein. In an example, the training allows a robot 120 to adapt and learn things on-the-fly, in real time, through in context learning. The on-the-fly learning can take into account the various preferences, skills, environment aware information, etc. to predict correct tasks for the robot 120.

As indicated above, the control ecosystem 300 includes one or more models configured to generate memory representations of the working environment 110. The memory may comprise latent representations, embeddings, or other implicit forms that capture visual, semantic, and language information about the environment. Generally, these models are trained to recognize objects in the environment, determine contextual relationships between objects, and identify, orchestrate, and perform tasks based on the identified objects and contextual relationships encoded in the memory.

Notably, the training module 350 is configured to train the models and libraries in the control ecosystem 300 to recognize specific, individualized objects and store information about those objects in the memory representations. This is an important distinction. To illustrate, consider, for example, a latent memory representation of a bedroom including embeddings for a door to a closet and a door to a bathroom. In originally creating the memory representation, a model may be trained to recognize each door, encode it in the latent space, and capture the contextual relationships for each door (e.g., this door leads to a closet, and this door leads to the bathroom) within the learned representations.

However, oftentimes, similar objects and relationships within the memory representation may need to be differentiated. For instance, continuing the example, the bathroom door may be lockable while the closet door is not lockable. In this case, models in the control ecosystem 300 are configured to encode particular information relevant to each similar object within the latent representations - e.g., encoding in the embedding for the closet door that it does not have a lock, while encoding in the embedding for the bathroom door that it does have a lock. This additional, particularized information encoded in the memory representations may influence how tasks and actions are performed within the working environment 110. For example, the action set for the task “open the door” will be different for the closet door and the bathroom door because the bathroom door includes a lock. In this case, the action set for the closet door will not account for the possibility of a locked door while the action set for the bathroom door does account for that possibility.

The training module 350 can also identify additional relevant information that may differentiate similar objects within an environment and encode that information in the memory representations. For example, continuing with the above example, the training module 350 may identify that the bathroom door leads to an area where enhanced data protections may be needed, while the closet door does not, and encode this distinction in the latent representations. Similarly, the training module 350 may identify that more force is needed to open the closet door (e.g., due to a mechanical impedance of the door in the door frame) relative to a normal door. In this case, the training module 350 may identify the requisite amount of force to open the door (e.g., using reinforcement learning) and store that information in the memory representation for future use such that it can be easily accessed and implemented within the control ecosystem 300. The training module 350 may encode this information within the latent representations or embeddings associated with the closet door.

The training module 350 can similarly train skills corresponding to capabilities in a skill library 320. For example, a skill for traversing through a household may involve the robot's neural network generating motor commands based on images and task inputs to navigate at a preferred speed. However, in some working environments, a higher degree of friction may be present on the floor and the neural network may need to adapt its motor command generation to achieve the preferred speed. In this case, the training module 350 “trains” the skill to perform properly in the working environment 110 by updating the model's parameters based on observed performance.

Overall, the training module 350 is configured to train the various models, skills, memory representations, etc., in the control ecosystem 300 to operate within its individual, contextual working environment 110. This allows an “off the shelf” robot 120 with “pre-trained” capabilities to adapt its models and libraries to accomplish objectives in the working environment 110 more efficiently.

Additionally, the training module 350 is configured to train the models and libraries within the control ecosystem 300 to adapt new skills and capabilities within the working environment 110. There are several ways in which the training module 350 may do so.

In an example, the training module 350 may ingest media (e.g., images, videos, sensor data, etc.) related to a skill, and train one or more models to generate motor commands based on the ingested information. For instance, the training module 350 may ingest images and videos portraying a skill, and train the models within the ecosystem to generate appropriate motor commands for performing those skills. In some cases, the media may reflect humans (rather than robots 120) and the training module 350 may adapt the human demonstrations to corresponding robot capabilities by training the neural network to generate motor commands that accomplish similar objectives. Other examples are also possible.

In an example, the training module 350 may ingest information from the robot 120 as a user guides the robot 120 through one or more actions in a skill (e.g., images, videos, sensor data, motor commands, etc.), and train one or more models to generate motor commands based on the ingested information. For instance, a user may guide a robot's arms through the process of feeding fish in a fish bowl using fish food, and the robot 120 records the sensor information and motor commands during the demonstration to train the neural network to perform this skill autonomously. Other examples are also possible.

In an example, the training module 350 may ingest a new skill from a system (e.g., via a software update), and the training module 350 may adapt the new skill to the contextualized working environment 110 of the robot 120. For instance, the training module 350 may ingest a new skill capability such as “turn off the lights” and the training module 350 may adapt the neural network to generate appropriate motor commands for the robot 120 in the working environment 110. This may include adapting the model's parameters and learned representations as needed.

In an example, the training module 350 may participate in the federated training of a new skill. In federated training, one or more user devices 140 and one or more robots 120 in disparate system environments train models to accomplish a similar skill. For instance, a group of users may train their robot 120 to “set the table.” In this situation, each user employs a training module 350 to train a centralized model to generate motor commands for setting the table. Because the system environments, robots, and working environments are all different, the federated training accounts for more possibilities and differences in developing the neural network's capability to generate appropriate motor commands for setting the table. In turn, the skills and capabilities generated by federated training may then be adapted to robots 120 in different system environments and working environment 110. Typically, this type of training improves the ability for a skill to be adapted easily for a new working environment 110 because of the broad training base.

Additionally, the training module 350 is configured to train the models and libraries within the control ecosystem 300 to adapt new robots 120 within the working environment 110. There are several ways in which the training module 350 may do so.

To illustrate, consider an example where a working environment 110 includes one robot 120, and that training module 350 has trained the various models and libraries with the control ecosystem 300 to generate motor commands efficiently. A user then obtains a new robot 120 to add to the working environment 110. Assuming the robots 120 are similarly configured, adapting the trained models to the new robot 120 is straightforward—merely applying the already trained models and libraries to the new robot 120, with some modifications that allow for multiple robots 120 to coordinate their actions.

However, this situation becomes more complex when the new robot 120 is differently configured from the old robot 120. For instance, the new robot 120 may have different or additional hardware relative to the old robot 120 (e.g., a new model, or a different model). In this case, the training module 350 is configured to map the models and libraries trained for the old robot 120 to that of the new robot 120. In other words, the training module 350 will adapt the models to generate motor commands appropriate for the hardware of the new robot 120, rather than having to wholly train the new robot 120 from scratch.

### Example Objectives and Actions

Several different objectives and actions are described above to highlight the functionality of an agentic robot 120 in a working environment 110 controlled by an agentic robot control ecosystem 300. Those objectives and actions are intended as examples and many others are also possible. Additionally, as noted above, those objectives and actions can vary in complexity, with some objectives including just a few actions performed by an individual robot 120, and other objectives including many actions orchestrated between several robots 120. Additional objective and action examples are described hereinbelow.

### Extrinsic Objectives

In some cases, objectives may utilize extrinsic information to generate the objective action series (“extrinsic objectives”). Within this context, extrinsic objectives are objectives that access information from, e.g., another external client device within the system environment 100, another application within the system environment, another external network system within the system environment 100, another external robot within the system environment 100, etc. Extrinsic objectives may also include those objectives that require a robot 120 to determine a specific current state of objects in the working environment 110 due to the transient nature of those objects.

An example of an extrinsic objective is “retrieve the package.” To illustrate, typically a robot 120 in the working environment 110 would be unaware of a package delivered to a door because it is unable to see when that package is delivered. However, the control ecosystem 300 may access extrinsic information that indicates a package is delivered and instruct the robot 120 to retrieve that package. For example, the ecosystem may access information received at an external network system 130 or the user device 140 indicating the package was delivered and generate an objective action series for the robot 120 to retrieve the package. Moreover, the objective action series may be influenced by the extrinsic information. For example, if the package is directed towards a first user, the robot 120 may place the package in the first user's bedroom, while if the package is directed towards a second user the robot 120 may place the package in the second user's bedroom. Similarly, the robot 120 may unpackage the package based on that extrinsic information. For example, if the contents of the package are perishable the robot 120 may place the contents in a refrigerator.

An example of an extrinsic objective is “do the laundry.” To illustrate, a robot 120 collecting laundry from around a house to place in a laundry machine may seem like a straightforward objective. However, it is an extrinsic objective due to the transient nature of the objects involved. For example, doing the laundry may involve sorting the objects for washing based on, e.g., the type of object (e.g., towel, bedding, clothes), how soiled the objects are, and the amount of laundry in those categories. Moreover, doing the laundry may include folding the clothes and sorting them for return to the appropriate location after the fact. Therefore, the robot 120 may first catalog the various objects on which it will perform laundry, check those objects against laundry information regarding each object in the ecosystem 300 (e.g., object type, owner, special care instructions, etc.), and generate the objective action series accordingly.

An example of an extrinsic objective is “buy groceries.” This is an extrinsic objective due to both the transient nature of identifying objects for purchasing, and interfacing with an external system to purchase those objects. Much like the laundry, buying the groceries includes taking a catalog of the foodstuffs in the house (e.g., pictures of the pantry, catalog of the fridge, etc.) and comparing that to a preferred state of the pantry (e.g., there are no eggs when we should have eggs, the cabbage is rotten and should be replaced). Using this information, the control ecosystem 300 identifies foodstuffs for purchase and transmits a purchase order for those foodstuffs to an external system. The robot 120 and control ecosystem 300 may generate an objective action series to put away the groceries when delivered.

More generally, an extrinsic objective is any objective corresponding to the maintenance or return to a preferred state. As an example, the objective of “keep the house clean” includes the robot 120 continuously monitoring the state of the house. Some aspects of the house can be quite transient due to daily use. For example, when people come in the floor gets dirty, or when the kitchen gets used the dishes need washing, etc. In these situations, given a generalized objective, the robot 120 can continually monitor the working environment 110 to discover changes to the current state of the house relative to the preferred state of the house due to transient interactions in the working environment 110. In turn, the control ecosystem 300 can generate the objective action series to accomplish the objective.

Other examples of extrinsic objectives are also possible.

### Intrinsic Objectives

On the other hand, in some cases, objectives may utilize intrinsic information to generate the objective action series (“intrinsic objectives”). Within this context, intrinsic objectives are objectives that access information from only sources within the system environment 100, and/or pertain to specific actions identified to accomplish a user-defined objective.

An example of an intrinsic objective is “unbox yourself.” In this case, when the robot 120 is purchased, it arrives to the working environment 110 in a package. The control ecosystem 300 may receive an indication to begin a startup procedure and the robot 120 may unbox itself using information only available within the system environment 100.

An example of an intrinsic objective is “pick up toys,” “pick up trash,” “clean the counter,” etc. In this case, the control ecosystem 300 and the robot 120 use information local to the working environment 110 to generate the objective action series for, e.g., picking up, translating, and putting down objects.

Other intrinsic objectives may include, e.g., loading the laundry machine or dishwasher, cleaning a table, watering plants, performing a hot towel service, making the bed, cleaning a toilet or a shower, mopping or sweeping the floor etc.

Additionally, an intrinsic objective may include “help me find my keys.” In this case the robot 120 and the control ecosystem 300 may maintain and/or access memory representing the location of the key object and relate that location to the user. In some cases, the robot 120 and the control ecosystem 300 may also generate an objective action series that helps the user discover the keys if they are not present in current or previous memory representations.

### Example Workflows

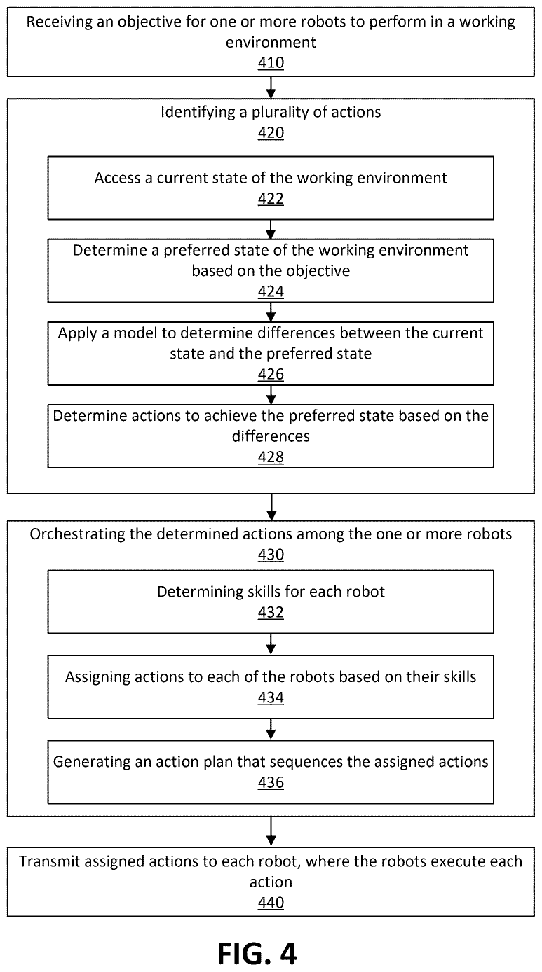

FIG. 4 is a workflow diagram for orchestrating multiple robots to accomplish an objective in a working environment, according to an example embodiment. In various configurations, the workflow 400 may include additional or fewer elements, and the elements may occur in a different order. Moreover, one or more of the elements in the workflow 400, or the workflow 400 itself, may be repeated.

At 410, the network system 130 receives an objective for one or more robots 120 to perform in the working environment 110. The objective may be received from a user device 140 as a natural language request. For example, in a residential working environment 110, the user device 140 may transmit a natural language request such as “clean the living room” or “organize the bedroom.” The network system 130 receives the natural language request and processes it to identify the objective for the robots 120.

At 420, the orchestration engine 310 of the network system 130 identifies a plurality of actions required to accomplish the objective. To do so, at 422, the orchestration engine 310 accesses sensor information describing a current state of the working environment 110. The sensor information comprises images captured by sensors 220 of one or more robots 120 operating in the working environment 110. For example, robots 120 in a house may capture images of different rooms showing the current positions and arrangements of objects. The orchestration engine 310 receives the images from the robots 120 over the network 150.

At 424, the orchestration engine 310 accesses an environment memory describing a preferred state of the working environment 110. The environment memory comprises memory representations that define preferred spatial and contextual relationships of objects in the working environment 110. For example, the preferred state may indicate that toys should be organized in a toy bin rather than scattered on the floor, or that kitchen counters should be clear of objects. The orchestration engine 310 retrieves the environment memory from the environmental memory data store 330. The environment memory facilitates comparison with the current state to determine what actions are needed to achieve the objective. In some cases, the environment memory may be trained into a model itself.

At 426, the orchestration engine 310 applies a model to determine differences between the current state and the preferred state. The orchestration engine 310 inputs sensor information representing the current state and the environment memory of the preferred state into the model. The model may be a visual language model or other model trained to compare memory representations and sensor information and identify differences. The model processes the inputs to determine spatial and contextual differences between the current state and preferred state. For example, the model may identify that toys are currently on the floor but should be in the toy bin according to the preferred state, or that books are scattered on a table but should be organized on a bookshelf.

At 428, the orchestration engine 310 determines actions to achieve the preferred state based on the differences. The orchestration engine 310 applies the model to the identified differences to generate actions that, when performed, will transform the current state into the preferred state. For example, if the model identified that toys are on the floor but should be in the toy bin, the orchestration engine 310 generates actions such as “put toys in the bin.” The orchestration engine 310 generates the plurality of actions needed to accomplish the objective by determining actions for each identified difference between the current state and preferred state.

At 430, the orchestration engine 310 orchestrates the determined actions among the one or more robots 120. That is, the orchestration engine 310 coordinates which robots 120 will perform which actions and in what sequence to efficiently accomplish the objective.

At 432, the orchestration engine 310 determines skills for each robot 120. The orchestration engine 310 accesses the skill library 320 for each robot 120 to identify what skills each robot possesses. Each skill represents a capability of the robot 120 to execute actions based on images and task inputs, where the robot's neural network directly outputs motor commands to accomplish those actions. For example, a first robot 120A may have skills for basic object manipulation such as picking up and placing objects, while a second robot 120B may have skills for more dexterous tasks such as cleaning surfaces or folding items. The orchestration engine 310 evaluates the skills of each robot 120 to determine which robots are capable of performing which actions from the plurality of actions.

At 434, the orchestration engine 310 assigns actions to each of the robots 120 based on their skills. The orchestration engine 310 matches the determined actions with the skills of available robots 120. For example, if an action requires picking up objects and a first robot 120A has object manipulation skills, the orchestration engine 310 assigns that action to the first robot 120A. If an action requires cleaning a surface and a second robot 120B has surface cleaning skills, the orchestration engine 310 assigns that action to the second robot 120B. The orchestration engine 310 distributes the plurality of actions among the robots 120 such that each robot receives actions matching its capabilities.

At 436, the orchestration engine 310 generates an action plan that sequences the assigned actions. The action plan specifies the order in which actions should be performed and coordinates timing between multiple robots 120. For example, the action plan may specify that a first robot 120A should complete actions of collecting objects before a second robot 120B begins actions of organizing those objects. The orchestration engine 310 generates the action plan by considering dependencies between actions, optimizing for efficient completion time, coordinating spatial positioning of robots 120 to prevent collisions, etc. Overall, the action plan sequences the assigned actions to achieve the preferred state of the working environment 110.

At 440, the network system 130 transmits assigned actions to each robot 120, where the robots 120 execute each action. The network system 130 transmits the actions from the action plan to each robot 120 over the network 150. Each robot 120 receives its assigned actions and executes those actions in the working environment 110. The robots 120 apply action execution models to generate motor commands that cause their mechanical systems 230 to perform the assigned actions. For example, a robot 120 may receive an assigned action to “pick up toy from floor” and apply an action execution model to sensor information to generate motor commands that navigate to the toy, grasp it, and lift it. The robots 120 execute their assigned actions according to the sequence specified in the action plan to accomplish the objective in the working environment 110.

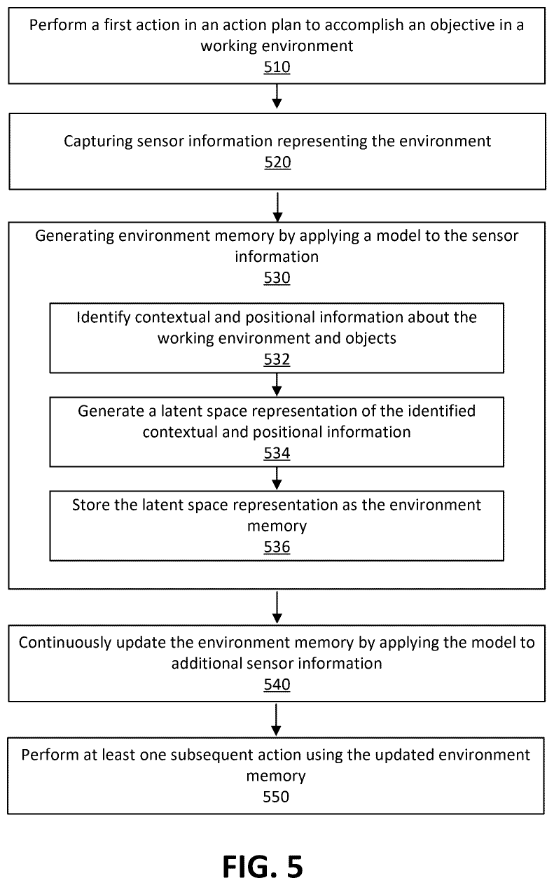

FIG. 5 is a workflow diagram for updating an environment memory of a working environment in an agentic robot system, according to an example embodiment. In various configurations, the workflow 500 may include additional or fewer elements, and the elements may occur in a different order. Moreover, one or more of the elements in the workflow 500, or the workflow 500 itself, may be repeated.

At 510, the robot 120 performs a first action in an action plan to accomplish an objective in the working environment 110. The robot 120 receives the action plan from the network system 130 or generates the action plan using its control system 210. The robot 120 executes the first action by applying an action execution model to generate motor commands for the mechanical systems 230. The motor commands cause the mechanical systems 230 to actuate and perform the first action in the working environment 110.

At 520, the sensors 220 of the robot 120 capture sensor information describing the working environment 110. The sensor information comprises images of the working environment 110 captured by vision sensors such as cameras. The sensors 220 may also capture additional sensor information such as proximity data from LiDAR or infrared sensors, tactile data from pressure or force sensors, or other measurements describing the working environment 110. The robot 120 captures the sensor information while performing the first action or immediately after completing the first action.

At 530, the robot 120 generates the environment memory representing the working environment 110 by applying a model to the sensor information.

At 532, the model identifies contextual and positional information about the working environment 110 and objects in the working environment 110 based on the sensor information. The model processes the images and other sensor information to recognize objects in the working environment 110, determine spatial positions of those objects, and establish contextual relationships between objects. For example, the model may identify that a toy is located on the floor, that a toy bin is positioned in a closet, and that the toy and toy bin have a functional relationship where toys should be placed in the toy bin.

At 534, the model generates a latent space representation of the identified contextual and positional information for the objects and working environment 110. The model encodes the identified information into latent vectors, embeddings, or other compressed representations that capture patterns and relationships in a learned form. The latent space representation encodes spatial layouts, object arrangements, contextual relationships, and other information about the working environment 110 without explicitly storing every measurement or coordinate. The latent space representation allows the robot 120 to work with learned patterns rather than explicit symbolic data.

At 536, the robot 120 stores the latent space representation as the environment memory. The stored environment memory represents the state of the working environment 110 after the robot 120 performed the first action.

At 540, as the robot 120 performs additional actions in the action plan in the working environment 110, the robot 120 continuously updates the memory by applying the model to additional sensor information captured by the robot 120. The sensors 220 capture additional sensor information as the robot 120 performs each subsequent action in the action plan. The robot 120 applies the model to the additional sensor information to identify updated contextual and positional information, generate updated latent space representations, and modify the environment memory accordingly. The continuous updating modifies the latent space representation of the contextual and positional information of the objects and working environment 110 to reflect changes that occur as the robot 120 performs actions. For example, if the robot 120 picks up a toy from the floor and places it in a toy bin, the continuous updating modifies the latent space representation to reflect that the toy is no longer on the floor but is now in the toy bin.

At 550, the robot 120 performs at least one subsequent action in the action plan using the updated memory. The robot 120 applies an action execution model to the updated memory and current sensor information to generate motor commands for performing the subsequent action. The updated memory provides contextual information about the current state of the working environment 110 that informs how the robot 120 should perform the subsequent action. For example, the updated memory may indicate that certain objects have already been moved to their preferred locations, allowing the robot 120 to focus the subsequent action on remaining objects that still need to be moved. The robot 120 continues to perform actions in the action plan, continuously updating the memory and using the updated memory to inform execution of subsequent actions, until the objective is accomplished.

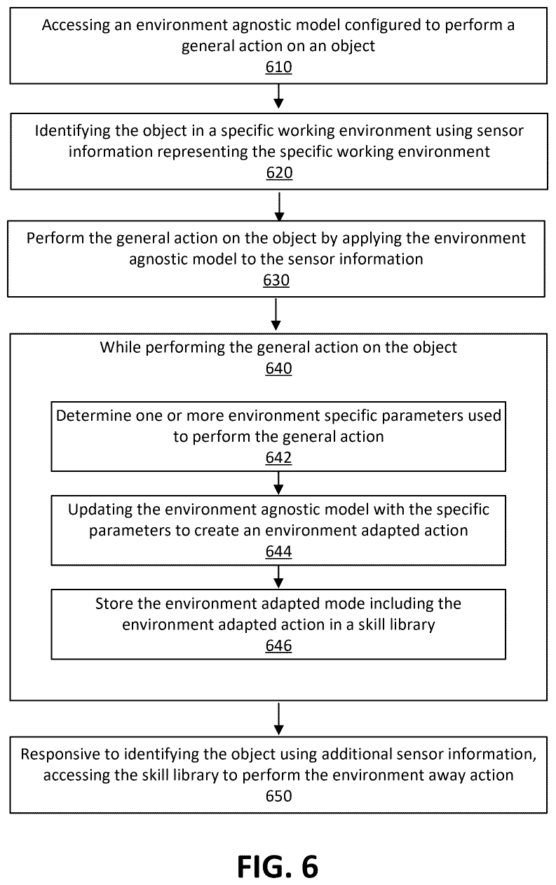

FIG. 6 is a workflow diagram for training a robot to perform environment-specific actions, according to an example embodiment. In various configurations, the workflow 600 may include additional or fewer elements, and the elements may occur in a different order. Moreover, one or more of the elements in the workflow 600, or the workflow 600 itself, may be repeated.

At 610, the robot 120 accesses an environment-agnostic model configured to perform a general action on an object. In this example, the environment-agnostic model represents a foundational capability that the robot 120 possesses through large-scale training across diverse environments (e.g., accessing a generic skill from a skill library). The environment-agnostic model takes images and objectives as inputs and directly outputs motor commands to accomplish the general action. For example, the environment-agnostic model may represent a general capability to “open door” that applies broadly across different types of doors without specific parameters for any particular door. The robot 120 may retrieve the environment-agnostic model from the skill library 320.

At 620, the robot 120 identifies the object in the specific working environment using sensor information representing the specific working environment. The sensors 220 of the robot 120 capture sensor information comprising images of the specific working environment 110. The robot 120 applies a model to the sensor information to identify the object on which to perform the general action. For example, the robot 120 may capture images of a bedroom and identify a specific closet door in that bedroom as the object on which to perform the general action of opening the door.

At 630, the robot 120 performs the general action on the object by applying the environment-agnostic model to the sensor information representing the specific working environment. The robot 120 inputs the sensor information into the environment-agnostic model, and the environment-agnostic model generates motor commands based on the sensor information and the general action. The mechanical systems 230 of the robot 120 execute the motor commands to perform the general action on the object. For example, the robot 120 applies the environment-agnostic model to images of the closet door, and the model generates motor commands that cause the robot 120 to approach the door, grasp the handle, and attempt to open the door.

At 640, while performing the general action on the object, the robot 120 determines environment specific parameters and updates the environment-agnostic model.

At 642, the robot 120 determines one or more environment specific parameters used to perform the general action on the object. The robot 120 captures sensor information while interacting with the object during execution of the general action. The sensor information may include force measurements, position measurements, velocity measurements, and other data captured by the sensors 220 during the interaction. The robot 120 analyzes the captured sensor information to identify parameters specific to performing the general action on this particular object in the specific working environment 110. For example, while opening the closet door, the robot 120 may determine that a specific force of 15 Newtons is required to overcome friction in the door hinges, or that the door handle must be rotated 45 degrees before the door will open.

At 644, the robot 120 updates the environment-agnostic model with the one or more environment specific parameters to create an environment-adapted model. The robot 120 modifies the environment-agnostic model by incorporating the determined environment specific parameters (e.g., updates the skill in the skill library for the working environment 110). The environment-adapted model is configured to perform the general action on the object in the specific working environment 110 as an environment-aware action using the environment specific parameters. For example, the robot 120 creates an environment-adapted model for “open closet door” that incorporates the specific force requirement of 15 Newtons and the handle rotation angle of 45 degrees. When the environment-adapted model is applied to sensor information showing the closet door, it generates motor commands that account for these environment specific parameters.

At 646, the robot 120 stores the environment-adapted model in the skill library 320. The stored environment-adapted model represents a new skill that the robot 120 can perform efficiently in the specific working environment 110. The skill library 320 maintains both the original environment-agnostic model and the environment-adapted model, allowing the robot 120 to use the appropriate model depending on the context.

At 650, responsive to identifying the object using additional sensor information representing the specific working environment, the robot 120 accesses the skill library 320 to perform the environment-aware action using the environment-adapted model. When the robot 120 subsequently encounters the same object in the specific working environment 110, the robot 120 captures additional sensor information and identifies the object. The robot 120 queries the skill library 320 and retrieves the environment-adapted model associated with that object. The robot 120 applies the environment-adapted model to the additional sensor information, and the environment-adapted model generates motor commands using the environment specific parameters. The mechanical systems 230 execute the motor commands to perform the environment-aware action. For example, when the robot 120 later needs to open the closet door again, it retrieves the environment-adapted model for “open closet door” from the skill library 320 and applies that model to generate motor commands that incorporate the learned force requirement and handle rotation angle, allowing the robot 120 to open the door more efficiently than when using the environment-agnostic model.

### Example Computer System

FIG. 7 is a block diagram illustrating components of an example machine for reading and executing instructions from a machine-readable medium, according to an example embodiment. Specifically, the various systems described herein above may be implemented using a computer system as demonstrated in the diagrams hereinabove. The computer system 700 can be used to execute instructions 724 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client system environment 100, or as a peer machine in a peer-to-peer (or distributed) system environment 100.

The machine may be a server computer, a client computer, a personal computer (PC), a tablet PC, a set-top box (STB), a smartphone, an internet of things (IoT) appliance, a network router, switch or bridge, or any machine capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes one or more processing units (generally processor 702). The processor 702 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 700 also includes a main memory 704. The computer system may include a storage unit 716. The processor 702, memory 704, and the storage unit 716 communicate via a bus 708.

In addition, the computer system 700 can include a static memory 706, a graphics display 710 (e.g., to drive a plasma display panel (PDP), a liquid crystal display (LCD), or a projector). The computer system 700 may also include alphanumeric input device 712 (e.g., a keyboard), a cursor control device 714 (e.g., a mouse, a trackball, a joystick, a motion sensor, or other pointing instrument), a signal generation device 718 (e.g., a speaker), and a network interface device 720, which also are configured to communicate via the bus 708.

The storage unit 716 includes a machine-readable medium 722 on which is stored instructions 724 (e.g., software) embodying any one or more of the methodologies or functions described herein. For example, the instructions 724 may include the functionalities of modules of the system described in FIG. 1. The instructions 724 may also reside, completely or at least partially, within the main memory 704 or within the processor 702 (e.g., within a processor's cache memory) during execution thereof by the computer system 700, the main memory 704 and the processor 702 also constituting machine-readable media. The instructions 724 may be transmitted or received over a network 726 (e.g., network 150) via the network interface device 720.

While machine-readable medium 722 is shown in an example embodiment to be a single medium, the term “machine-readable medium” should be taken to include a single medium or multiple media (e.g., a centralized or distributed database, or associated caches and servers) able to store the instructions 724. The term “machine-readable medium” shall also be taken to include any medium that is capable of storing instructions 724 for execution by the machine and that cause the machine to perform any one or more of the methodologies disclosed herein. The term “machine-readable medium” includes, but not be limited to, data repositories in the form of solid-state memories, optical media, and magnetic media.

### Additional Considerations

In the description above, for purposes of explanation, numerous specific details are set forth in order to provide a thorough understanding of the illustrated system and its operations. It will be apparent, however, to one skilled in the art that the system may be operated without these specific details. In other instances, structures and devices are shown in block diagram form in order to avoid obscuring the system.

Reference in the specification to “one embodiment” or “an embodiment” means that a particular feature, structure, or characteristic described in connection with the embodiment is included in at least one embodiment of the system. The appearances of the phrase “in one embodiment” in various places in the specification are not necessarily all referring to the same embodiment.

Some portions of the detailed descriptions are presented in terms of algorithms or models and symbolic representations of operations on data bits within a computer memory. An algorithm is here, and generally, conceived to be steps leading to a desired result. The steps are those requiring physical transformations or manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some of the operations described herein are performed by a computer physically mounted within a machine. This computer may be specially constructed for the required purposes, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of non-transitory computer-readable storage medium suitable for storing electronic instructions.

The figures and the description above relate to various embodiments by way of illustration only. It should be noted that from the following discussion, alternative embodiments of the structures and methods disclosed herein will be readily recognized as viable alternatives that may be employed without departing from the principles of what is claimed.

One or more embodiments have been described above, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct physical or electrical contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present), and B is true (or present), and both A and B is true (or present).

In addition, the use of the “a” or “an” are employed to describe elements and components of the embodiments herein. This is done merely for convenience and to give a general sense of the system. This description should be read to include one or at least one and the singular also includes the plural unless it is obvious that it is meant otherwise.

Upon reading this disclosure, those of skill in the art will appreciate still additional alternative structural and functional designs for a system and a process for implementing the functionality described herein. Thus, while particular embodiments and applications have been illustrated and described, it is to be understood that the disclosed embodiments are not limited to the precise construction and components disclosed herein. Various modifications, changes, and variations, which will be apparent to those, skilled in the art, may be made in the arrangement, operation, and details of the method and apparatus disclosed herein without departing from the spirit and scope defined in the appended claims.

What is claimed is:

1. A method for orchestrating multiple robots to accomplish an objective in a working environment, the method comprising:
receiving, at a network system, an objective for one or more robots to perform in the working environment;
determining, with an orchestration engine, a plurality of actions required to accomplish the objective by:
accessing sensor information describing a current state of the working environment, wherein the current state includes spatial and contextual relationships of objects in the working environment;
accessing an environment memory, the environment memory comprising a preferred state of the working environment that defines preferred spatial and contextual relationships of objects in the working environment;
applying a model to the sensor information and the environment memory to determine differences between current state and the preferred state; and
determining, using the model, the plurality of actions to achieve the preferred state based on the determined differences;
orchestrating, with the orchestration engine, the plurality of actions among the one or more robots by:
determining skills of each of the one or more robots based on a skill library for that robot;
assigning actions from the plurality of actions to the one or more robots based on their skills stored in a skill library;
generating an action plan that sequences the assigned actions to achieve the preferred state of the working environment; and
transmitting, to each of the one or more robots, their respective assigned actions from the action plan for execution in the working environment, each of the one or more robots perform their assigned task in the working environment.

2. The method of claim 1, wherein each of the one or more robots executes their assigned actions by applying an end-to-end model that directly generates motor commands from sensor information and the assigned actions without explicit decomposition into intermediate symbolic tasks.

3. The method of claim 1, wherein the model applied by the orchestration engine to determine the plurality of actions comprises a foundational model trained on large-scale multimodal datasets.

4. The method of claim 1, wherein the environment memory is generated by:
receiving sensor information from the one or more robots operating in the working environment;
applying a model to the sensor information to identify objects and contextual relationships between objects in the working environment; and
encoding the identified objects and contextual relationships into a latent space representation stored as the environment memory.

5. The method of claim 1, wherein the skill library for a first robot of the one or more robots differs from the skill library for a second robot of the one or more robots, and the orchestration engine assigns actions to the first robot and the second robot based on their respective different skill libraries.

6. The method of claim 1, wherein orchestrating the plurality of actions further comprises:
determining that additional sensor information is needed to coordinate actions between the one or more robots;
transmitting a request to at least one of the one or more robots specifying the additional sensor information needed; and
receiving the additional sensor information from the at least one robot in response to the request.

7. The method of claim 1, wherein each skill in the skill library represents a capability of a robot to execute actions based on images and task inputs by applying a neural network that directly outputs motor commands to accomplish those actions.

8. A non-transitory computer-readable medium storing instructions that, when executed by one or more processors, cause the one or more processors to perform operations comprising:
receiving an objective for one or more robots to perform in a working environment;
determining, with an orchestration engine, a plurality of actions required to accomplish the objective by:
accessing sensor information describing a current state of the working environment, wherein the current state includes spatial and contextual relationships of objects in the working environment;
accessing an environment memory, the environment memory comprising a preferred state of the working environment that defines preferred spatial and contextual relationships of objects in the working environment;
applying a model to the sensor information and the environment memory to determine differences between current state and the preferred state; and
determining, using the model, the plurality of actions to achieve the preferred state based on the determined differences;
orchestrating, with the orchestration engine, the plurality of actions among the one or more robots by:
determining skills of each of the one or more robots based on a skill library for that robot;
assigning actions from the plurality of actions to the one or more robots based on their skills stored in a skill library;
generating an action plan that sequences the assigned actions to achieve the preferred state of the working environment; and
transmitting, to each of the one or more robots, their respective assigned actions from the action plan for execution in the working environment, each of the one or more robots perform their assigned task in the working environment.

9. The non-transitory computer-readable medium of claim 8, wherein each of the one or more robots executes their assigned actions by applying an end-to-end model that directly generates motor commands from sensor information and the assigned actions without explicit decomposition into intermediate symbolic tasks.

10. The non-transitory computer-readable medium of claim 8, wherein the model applied by the orchestration engine to determine the plurality of actions comprises a foundational model trained on large-scale multimodal datasets.

11. The non-transitory computer-readable medium of claim 8, wherein the environment memory is generated by:
receiving sensor information from the one or more robots operating in the working environment;
applying a model to the sensor information to identify objects and contextual relationships between objects in the working environment; and
encoding the identified objects and contextual relationships into a latent space representation stored as the environment memory.

12. The non-transitory computer-readable medium of claim 8, wherein the skill library for a first robot of the one or more robots differs from the skill library for a second robot of the one or more robots, and the orchestration engine assigns actions to the first robot and the second robot based on their respective different skill libraries.

13. The non-transitory computer-readable medium of claim 8, wherein orchestrating the plurality of actions further comprises:
determining that additional sensor information is needed to coordinate actions between the one or more robots;
transmitting a request to at least one of the one or more robots specifying the additional sensor information needed; and
receiving the additional sensor information from the at least one robot in response to the request.

14. The non-transitory computer-readable medium of claim 8, wherein each skill in the skill library represents a capability of a robot to execute actions based on images and task inputs by applying a neural network that directly outputs motor commands to accomplish those actions.

15. A system for orchestrating multiple robots to accomplish an objective in a working environment, the system comprising:
a network system comprising one or more processors and memory storing instructions that, when executed by the one or more processors, cause the network system to:
receive an objective for one or more robots to perform in the working environment;
determine, with an orchestration engine, a plurality of actions required to accomplish the objective by:
accessing sensor information describing a current state of the working environment, wherein the current state includes spatial and contextual relationships of objects in the working environment;
accessing an environment memory, the environment memory comprising a preferred state of the working environment that defines preferred spatial and contextual relationships of objects in the working environment;
applying a model to the sensor information and the environment memory to determine differences between current state and the preferred state; and
determining, using the model, the plurality of actions to achieve the preferred state based on the determined differences;
orchestrate, with the orchestration engine, the plurality of actions among the one or more robots by:
determining skills of each of the one or more robots based on a skill library for that robot;
assigning actions from the plurality of actions to the one or more robots based on their skills stored in a skill library;
generating an action plan that sequences the assigned actions to achieve the preferred state of the working environment; and
transmit, to each of the one or more robots, their respective assigned actions from the action plan for execution in the working environment, each of the one or more robots perform their assigned task in the working environment.

16. The system of claim 15, wherein each of the one or more robots executes their assigned actions by applying an end-to-end model that directly generates motor commands from sensor information and the assigned actions without explicit decomposition into intermediate symbolic tasks.

17. The system of claim 15, wherein the model applied by the orchestration engine to determine the plurality of actions comprises a foundational model trained on large-scale multimodal datasets.

18. The system of claim 15, wherein the environment memory is generated by:
receiving sensor information from the one or more robots operating in the working environment;
applying a model to the sensor information to identify objects and contextual relationships between objects in the working environment; and
encoding the identified objects and contextual relationships into a latent space representation stored as the environment memory.

19. The system of claim 15, wherein the skill library for a first robot of the one or more robots differs from the skill library for a second robot of the one or more robots, and the orchestration engine assigns actions to the first robot and the second robot based on their respective different skill libraries.

20. The system of claim 15, wherein orchestrating the plurality of actions further comprises:
determining that additional sensor information is needed to coordinate actions between the one or more robots;
transmitting a request to at least one of the one or more robots specifying the additional sensor information needed; and
receiving the additional sensor information from the at least one robot in response to the request.
